(19) United States
(12) Patent Application Publication
(10) Pub. No.: US 2003/0129397 A1
(43) Pub. Date: Jul. 10, 2003

(54) Coated optical fibers using adhesion promoters, and methods for making and using same

(76) Inventors: Daniel A. Wilson, Cincinnati, OH (US); Timothy E. Myers, Mason, OH (US); Matthew M. Ellison, Mason, OH (US)

Correspondence Address: STEVENS DAVIS MILLER & MOSHER, LLP, 1615 L STREET, NW, SUITE 850, WASHINGTON, DC, 20036, US

(21) Appl. No.: 10/235,769

(22) Filed: Sep. 6, 2002

Related U.S. Application Data
(60) Provisional application No. 60/317,459, filed on Sep. 7, 2001.

(51) Int. Cl. C08G 77/04; D02G 3/00

(52) U.S. Cl. 428/375; 385/128; 528/34

(57) ABSTRACT

The present invention provides a radiation curable coating composition for forming a polymeric coating on a glass optical fiber, the composition comprising a mixture of: a base radiation curable liquid composition capable of forming a polymeric coating; at least one adhesion promoter selected from the group consisting of bis-silyl amines, diacrylated silane tertiary amine, acetoxy functional silanes, trifunctional isocyanurates and mixtures thereof, and 0 to about 10 percent by weight of one or more photoinitiators. The present invention also includes a coated optical fiber, a method for making an optical fiber and compositions containing adhesion promoters that do not undergo free radical reaction with base radiation curable pre-polymer of the composition.

This claims priority under 35 U.S.C. Section 119 from U.S. provisional patent application serial No. 60/317,459, filed Sep. 7, 2001, incorporated herein by reference in its entirety.

### BACKGROUND OF THE INVENTION

1. Field of the Invention

The present invention relates to optical fibers with coatings comprising bis(trimethoxysilylpropyl) amine adhesion promoters.

2. Background Discussion

Strong optical fibers that have very few intrinsic defects are suitable for light transmission. However, optical fibers are easily damaged by exposure to the environment, including dust and moisture, and even small flaws can render the fiber brittle and easily broken by a weak external force.

The coating of optical glass fibers with low tensile modulus resin coatings to protect these fibers against abrasion is known, as is the desirability of using coating compositions which cure rapidly on exposure to ultraviolet radiation for this purpose. In many instances it is desired to have the coating adhere strongly to the glass fiber surface, and to maintain this adhesion despite exposure to high humidity atmospheres. However, the ultraviolet-curing coatings which provide appropriate coatings for the optical glass fiber are not strongly adherent to the glass surface. Moreover, the limited adhesion which does exist is markedly impaired when moisture penetrates the coating.

Accordingly, optical fibers have conventionally been provided with at least one resin coating, preferably immediately after preparation of the optical fibers. More commonly, two resin coatings are provided, namely a primary or buffer inner coating and a secondary outer coating. U.S. Pat. Nos. 6,048,911 and 6,014,488 to Shustack disclose optical fibers containing either or both primary and secondary coatings. These patents are incorporated herein by reference in their entirety.

The primary coating is applied directly to the glass fiber and, when cured, forms a soft, rubbery, compliant material that serves as a buffer to cushion and protect the fiber by relieving the stresses created when the fiber is bent, cabled or spooled. Such stress might otherwise induce microbending of the fibers and cause attenuation of the light traveling through them, resulting in inefficient signal transmission. The secondary coating is applied over the primary coating and, when cured, functions as a hard protective outer layer, preventing damage to the glass fiber during processing and use.

Certain characteristics are desirable for the primary coating layer. For example, it must maintain adequate adhesion to the glass fiber during thermal and hydrolytic aging, yet be strippable therefrom for splicing purposes. The tensile modulus of the primary coating must be low to cushion and protect the fiber by readily relieving the stresses on the fiber which can induce microbending and consequent inefficient signal transmission. This cushioning effect must be maintained through the temperature range to which the fiber may be exposed throughout its lifetime.

The secondary coating also must have a number of qualities, including a relatively high glass transition temperature (Tg), i.e., about 50° C., and a high tensile modulus, i.e., about 100,000 psi at 25° C. It is desirable for the secondary coating to have a Tg higher than its highest use temperature, because at or near the Tg of a polymer, many physical properties such as modulus, tensile strength, thermal expansion coefficient, moisture absorptivity and so forth, change dramatically with small changes in temperature. This results in large changes in the fiber characteristics.

Both the primary and secondary coating should undergo minimal changes in physical properties on exposure to moisture. Many polymeric coating materials experience significant hydrolysis, plasticization, softening and loss of protective function in the presence of water.

Another important property of coatings is that, when cured, they must contain little unreacted material. While ultraviolet curable materials are often referred to as 100 percent solids, they may still contain a significant amount of chemically unreacted material after the ultraviolet cure. This unreacted material can be extractable with solvent or water, or it can be volatile under certain conditions. The presence of an extractable or volatile component in optical fiber products can cause problems detrimental to the fibers. Such problems may manifest themselves throughout the lifetime of the optical fiber.

Both the primary and secondary coatings should also have a relatively high refractive index, i.e., greater than that of the cladding material of the fiber to be coated. This high refractive index allows for a refractive index differential between the glass cladding and the coatings. This differential enables the coatings to strip out errant light, that is, refract errant light signals away from the glass core and provides the ability to monitor the concentricity or geometry of the coated fiber.

Typically, the coating that contacts the fiber includes an adhesion promoter. There are a number of properties that would be desirable in an adhesion promoter: (1) increase adhesion of the coating to glass; (2) protect the glass from stress corrosion; (3) be compatible with the coating formulation (e.g., not adversely affect clarity); (4) be stable in a formulated product; (5) maintain adhesion and corrosion resistance in accelerated aging (95% relative humidity, soaking in water, and thermal aging); and (6) not be cost prohibitive. A number of available adhesion promoters adversely retard coating cure speed. Rapid cure of coatings is an important property in commercial optical fiber production. Thus, it would be desirable to develop an adhesion promoter that is effective in promoting adhesion but does not significantly retard cure speed.

U.S. Pat. No. 4,849,462 to Bishop discloses optical glass fiber having its glass surface adherently coated with an ultraviolet-cured coating of a liquid ultraviolet-curable coating composition is disclosed in which the composition comprises an ultraviolet-curable polymeric polyacrylate, a photoinitiator to render the composition curable with ultraviolet light, and from about 0.5% to about 5% of the coating composition of a polyalkoxy silane containing an organic substituent carrying a single mercaptyl hydrogen atom capable of reacting with acrylate unsaturation by Michael adduction.

U.S. Pat. No. 5,977,202 to Chawla et al discloses a radiation-curable composition for use as an optical fiber material or coating comprising the combination of the following pre-mixture ingredients: (A) about 5 wt. % to about 95 wt. % of one or more radiation-curable oligomers, (B) about 5 wt. % to about 95 wt. % of one or more monomer diluents, (C) optionally, one or more photoinitiators, (D) about 0.1 wt. % to about 30 wt. % of one or more adhesion promoters represented by: (R¹-L)₄—X—Si(OR²)X wherein R¹ is a group comprising an ethylenically unsaturated radiation-curable group; and the three R¹ groups independently of each other are C1-C10 groups; wherein X=1-3; and L is a linking group which comprises one or more alkoxy or branched propoxy groups.

### OBJECTS OF THE INVENTION

The present invention has the following preferred objects.

It is an object of the present invention to provide a coated optical fiber.

It is another object of the present invention to provide a process for preparing a coated optical fiber.

It is another object of the invention to provide an optical fiber assembly, for example, an optical fiber ribbon including the coated optical fibers.

It is another object of the present invention to increase adhesion of a coating to glass while not adversely affecting cure speed.

It is another object of the present invention to protect the glass from stress corrosion.

It is another object of the present invention to provide adhesion promoters which are compatible with the coating formulation (e.g., not adversely affect clarity).

It is another object of the present invention to provide adhesion promoters which are stable in a formulated product.

It is another object of the present invention to provide adhesion promoters that maintain adhesion and corrosion resistance in accelerated aging (95% relative humidity soaking in water, and thermal aging).

It is another object of the present invention to provide adhesion promoters which are not cost prohibitive.

These and other objects of the invention will become apparent from the following descriptions.

### SUMMARY OF THE INVENTION

The present invention provides a radiation curable coating composition for forming a polymeric coating on a glass optical fiber, the composition comprising a mixture of:

a base radiation curable liquid composition capable of forming a polymeric coating;

at least one adhesion promoter selected from the group consisting of bis-silyl amines, diacrylated silane tertiary amine, acetoxy functional silanes, trifunctional isocyanurate silanes and mixtures thereof, and

0 to about 10 percent by weight of one or more photoinitiators;

with the provisos that

A. when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates, and

B. when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines, diacrylated silane tertiary amine, acetoxy functional silanes, trifunctional isocyanurates other than tris[(trimethoxysilyl)propyl]-isocyanurate.

Typically,

A. when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates other than tris[(trimethoxysilyl)propyl]-isocyanurate, and

B. when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines other than bis(trimethoxysilyl)propylamine, diacrylated silane tertiary amine, acetoxy functional silanes, trifunctional isocyanurates other than tris[(trimethoxysilyl)propyl]-isocyanurate.

The coating is typically any coating of an optical gass fiber, but most typically is a coating which contacts the glass surface of the fiber, e.g., primary coating.

Such oligomers having a saturated aliphatic backbone between at least two of the terminal ends with at least one epoxide group are disclosed by U.S. Pat. No. 5,985,952 to Levy incorporated herein by reference. There may be zero percent photoinitiator when curing is achieved through electron beam irradiation.

The base radiation curable liquid composition capable of forming a polymeric coating comprises one or more radiation curable pre-polymers. A radiation curable pre-polymer is an oligomer, monomer or combinations thereof that are reactive upon radiation curing to form a polymer.

The invention also includes: a coated optical fiber comprising: an optical fiber; and a radiation-cured coating on the optical fiber, wherein the coating is formed from a mixture comprising: composition comprising a mixture of: a base radiation curable liquid composition capable of forming a polymeric coating; and at least one adhesion promoter selected from the group consisting of bis-silyl amines, diacrylated silane tertiary amine, acetoxy functional silanes, trifunctional isocyanurates and mixtures thereof.

The present invention also provides a process for preparing an optical fiber by applying to an optical fiber a coating formed from a reaction mixture that contains the aforementioned adhesion promoter, and radiation-curing the coating on the optical fiber, i.e., in situ; a composition for coating an optical fiber formed from a reaction mixture that contains the one or more above-described adhesion promoters.

The present invention also provides an optical fiber ribbon including the above-described optical fibers and coating, and a matrix material, the fibers held together in a parallel arrangement by the matrix material.

The coatings employed in the optical fibers according to the present invention may form either primary coatings, secondary coatings or both. They exhibit a combination of good abrasion resistance, moisture resistance, thermal stability and other desired characteristics.

Advantageously, the adhesion promoters of the present invention preferably maintain adhesion without significantly retarding coating cure speed.

Unexpectedly, it has been discovered that silane compounds which do not undergo free radical reactions with the base mixture are effective adhesion promoters on glass fiber. A number of the above listed silanes meet this criteria.

The ingredients that form the coating include, based on the weight of all of the ingredients typically include,

one or more base oligomers,

optionally, one or more reactive diluent monomers,

about 0.05 to about 30 weight percent of one or more of the above-mentioned adhesion promoters selected from the group consisting of bis-silyl amines, diacrylated silane tertiary amine, acetoxy functional silanes, trifunctional isocyanurates and mixtures thereof,

0 to about 10 weight percent of one or more photoinitiators, and

optionally one or more additives such as light sensitive and light absorbing components, catalysts, lubricants, inhibitors, wetting agents, antioxidants, stabilizers, pigments and dyes.

For example, the ingredients that form the coating may include, based on the weight of all of the ingredients,

about 5 to about 95 weight percent of one or more base oligomers,

about 5 to about 95 weight percent of one or more reactive diluent monomers,

about 0.05 to about 30 weight percent of one or more of the above-mentioned adhesion promoters selected from the group consisting of bis-silyl amines, diacrylated silane tertiary amine, acetoxy functional silanes, trifunctional isocyanurates and mixtures thereof,

0 to about 10 weight percent of one or more photoinitiators, and 0 to about 10 weight percent of one or more one or more additives such as light sensitive and light absorbing components, catalysts, lubricants, wetting agents, antioxidants, stabilizers, pigments and dyes;

with the provisos that

A. when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates, and

B. when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines, diacrylated silane tertiary amine, acetoxy functional silanes, trifunctional isocyanurates other than tris[(trimethoxysilyl)propyl]-isocyanurate.

In the present description, the terms “acrylate” and “acrylated” shall all also include “methacrylate” and “methacrylated,” and “polyacrylated” shall also include “polymethacrylated,” unless the context clearly indicates otherwise, e.g., in lists of formally named compounds. Also, in the present application, all composition percents are weight percents unless otherwise indicated. Also, in the present application, all listed patents and patent applications are incorporated herein by reference.

For example, the composition may comprise:

one or more radiation curable pre-polymers,

about 0.05 to about 30 weight percent of at least one adhesion promoter selected from the group consisting of bis-silyl amines, diacrylated silane based on tertiary amine, acetoxy functional silanes, trifunctional isocyanurates and mixtures thereof, wherein the bis-silyl amines are of formula I

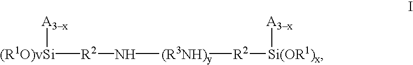

wherein each R¹ is independently C1-C4 alkyl, preferably C1 or C2 alkyl;

wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;

each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;

each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;

X is 1 to 3;

V is 1 to 3; and

Y is 0 to 1, and

0 to about 10 percent by weight of one or more photoinitiators;

with the provisos that

A. when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates, and

B. when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines, diacrylated silane tertiary amine, acetoxy functional silanes, trifunctional isocyanurates other than tris[(trimethoxysilyl)propyl]-isocyanurate.

### BRIEF DESCRIPTION OF THE DRAWINGS

FIG. 1 is a cross-sectional side view of a portion an of optical fiber ribbon.

FIG. 1A is a cross-sectional view of a coated optical fiber of the optical fiber ribbon of FIG. 1 being cut for stripping.

### DESCRIPTION OF THE PREFERRED EMBODIMENTS

The coated optical fibers of the preferred embodiments of the present invention comprise a glass optical fiber and a radiation-cured coating on the fiber. The glass optical fiber may be of any design known in the art. For example, the glass fiber may comprise a glass core and a glass cladding layer. The core may comprise silica doped with oxides of germanium or phosphorous or other impurities, and the cladding may comprise a pure or doped silicate, for example a fluorosilicate. In an alternative embodiment, the glass fibers may comprise a polymer-clad silica glass core. Examples of polymer claddings known in the art and suitable for use in this embodiment include organosiloxanes such as polydimethylsiloxane, fluorinated acrylic polymer or the like. Glass optical fibers of these types are well known in the art and are suitable for use in the present invention. Examples of radiation curable compositions for optical fiber materials are disclosed by U.S. Pat. Nos. 5,146,531; 5,352,712; 5,527,835; 5,536,529; 5,744,514; 6,014,488; and 6,048,911; all of which are incorporated herein by reference.

At least one radiation-cured coating according to the present invention is provided on the glass optical fiber. The radiation-cured coating according to the present invention may be applied directly to the glass optical fiber or, alternatively, to a coated glass optical fiber, in which case it is a secondary coating. Alternatively, the inventive coating may form both the primary and secondary coatings on an optical fiber.

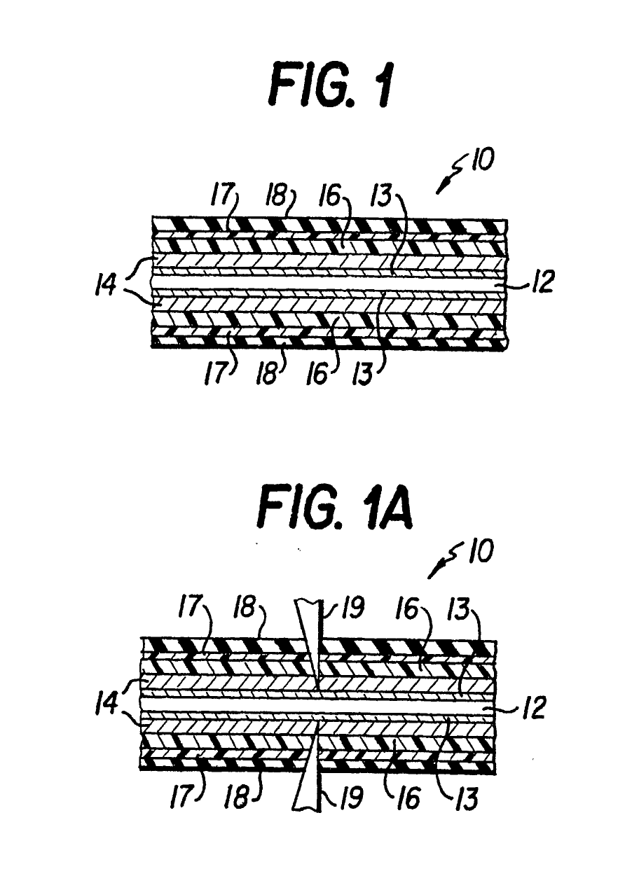

As shown in FIG. 1, a typically coated fiber 10 has a glass core 12, cladding 13, a primary coating 14, a secondary coating 16, ink 17 and a matrix 18 for holding a plurality of coated optical fibers together to form an optical ribbon. FIG. 1A shows the coated optical fiber of FIG. 1 being cut prior to stripping by blades 19.

Generally the primary coating 14 and secondary coating 16 are each approximately 1 mil thick. Ink, if any, may be present as a layer 17 that is 3-5 microns thick and located between the matrix 18 and the outer surface of the secondary coating 16.

### Components of the Coating

As stated above, the present invention provides a radiation curable coating composition for forming a polymeric coating on a glass optical fiber, the composition comprising a mixture of:

a base radiation curable liquid composition capable of forming a polymeric coating;

at least one adhesion promoter selected from the group consisting of bis-silyl amines, diacrylated silane tertiary amine, acetoxy functional silanes, tri functional isocyanurates and mixtures thereof, and

0 to about 10 percent by weight of one or more photoinitiators;

with the provisos that

A. when the adhesion promoter contains bis(trimethoxysilyl)propylamine the coating composition (i) is free of oligomer having a saturated aliphatic backbone between at least two of the terminal ends with at least one epoxide group, and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates, and

B. when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines, diacrylated silane tertiary amine, acetoxy functional silanes, trifunctional isocyanurates other than tris[(trimethoxysilyl)propyl]-isocyanurate.

Typically,

A. when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates other than tris[(trimethoxysilyl)propyl]-isocyanurate, and

B. when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines other than bis(trimethoxysilyl)propylamine, diacrylated silane tertiary amine, acetoxy functional silanes, trifunctional isocyanurates other than tris[(trimethoxysilyl)propyl]-isocyanurate.

An exemplary reaction mixture that forms a coating, e.g., either a primary coating, a secondary coating, or any coating which contacts the optic glass fiber, possessing the desired properties comprises the following components:

(I) about 5 to about 95 weight % of one or more reactive base oligomers;

(II) about 5 to about 95 weight % of one or more reactive diluent monomer;

(III) about 0.05 to about 30 weight %, preferably 0.05 to 10 weight %, bis-silyl amines, diacrylated silane tertiary amine, acetoxy functional silanes, trifunctional isocyanurates and mixtures thereof;

(IV) one or more optional photoinitiators; and

(V) one or more optional additives such as light sensitive and light absorbing components, catalysts, lubricants, inhibitors, wetting agents, antioxidants, stabilizers, pigments and dyes;

with the provisos that

A. when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates, and

B. when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines, diacrylated silane tertiary amine, acetoxy functional silanes, trifunctional isocyanurates other than tris[(trimethoxysilyl)propyl]-isocyanurate.

Typically,

A. when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates other than tris[(trimethoxysilyl)propyl]-isocyanurate, and

B. when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines other than bis(trimethoxysilyl)propylamine, diacrylated silane tertiary amine, acetoxy functional silanes, trifunctional isocyanurates other than tris[(trimethoxysilyl)propyl]-isocyanurate.

The following sections describe the above components in greater detail.

I. Base Oligomer

A. Urethane Oligomers

In one embodiment of the invention, the base oligomers are capable of homopolymerization. Preferably, they are urethane oligomers that are wholly aliphatic and acrylate-terminated.

The base oligomer typically constitutes from about 5 to about 95, typically 10 to about 90, percent by weight of the uncured coating material, based on the total weight of the ingredients. The preferred base oligomer, comprises acrylate-terminated urethane oligomer that constitutes from about 40 to about 80 percent by weight of the ingredients. If less than about 10 percent by weight of urethane oligomer is used, flexibility, elongation to break and overall toughness suffer.

The acrylate-terminated urethane oligomer preferably utilized in the present invention is the reaction product of (i) an aliphatic polyol; (ii) an aliphatic polyisocyanate; and (iii) an endcapping monomer capable of supplying a reactive terminus, either acrylate or methacrylate. This urethane oligomer may contain urethane acrylates based on polyesters and acrylics, but preferably contains only the above kinds of oligomers, for optimal long term stability.

The reagent polyol (i) may be an aliphatic polyol which does not adversely affect the properties of the ingredients when cured. Examples include polyether polyols; hydrocarbon

polyols; polycarbonate polyols; polyisocyanate polyols; and mixtures thereof. Polyether polyol backbones are preferred, because, in general, they have good solvent resistance, high elongation and good hydrolytic stability. The polyether polyol is typically based on a straight chain, branched or cyclic alkylene oxide wherein the alkyl group contains about one to about twelve carbon atoms. Polyether diols and triols are preferred because they confer good solvent resistance and are relatively inexpensive.

If an oligomeric polyether diol is used, the polyether may include, for example, substantially non-crystalline polyethers. The oligomer may include polyethers comprising repeating units of one or more of the following monomer units:

—O—CH₂—CH₂

—O—CH₂—CH₂—CH₂

—O—CH₂—CH(CH₃)—

—O—CH₂—CH₂—CH₂—CH₂

—O—CH₂—CH(CH₃)—CH₂

—O—CH₂—CH(CH)₃—CH₂—CH₂

—O—CH(CH₃)—CH₂—CH₂—CH₂

—O—CH(CH₂CH₃)—CH₂

—O—CH₂—C(CH₃)(CH₃)—, and the like.

An example of a polyether polyol that can be used is the polymerization product of (i) tetrahydrofuran, or (ii) a mixture of 20 percent by weight of 3-methyltetrahydrofuran and 80 percent by weight of tetrahydrofuran, both of which have undergone a ring opening polymerization. This latter polyether copolymer contains both branched and non-branched oxyalkylene repeating units and is marketed as PTGL 1000 (Hodogaya Chemical Company of Japan). Another example of a polyether in this series which can be used is PTGL 2000 (Hodogaya Chemical Company). Butyleneoxy repeat units are preferred to impart flexibility to one oligomer in particular and the pre-polymer system in general.

If a polyolefin diol is used, the polyolefin is preferably a linear or branched hydrocarbon containing a plurality of hydroxyl end groups. Fully saturated, for example, hydrogenated hydrocarbons, are preferred because the long term stability of the cured coating increases as the degree of unsaturation decreases. Examples of hydrocarbon diols include, for example, hydroxyl-terminated, fully or partially hydrogenated 1,2-polybutadiene; 1,4- and 1,2-polybutadiene copolymers, 1,2-polybutadiene-ethylene or -propylene copolymers, polyisobutylene polyol; mixtures thereof, and the like.

Representative hydrocarbon polyols which may be used include but are not limited to those based on a linear or branched hydrocarbon polymer of from 600 to 4,000 molecular weight such as fully or partially hydrogenated 1,2-polybutadiene; 1,2-polybutadiene hydrogenated to an iodine number of from 9 to 21; and fully or partially hydrogenated polyisobutylene. Unsaturated hydrocarbon polyols are not as desirable because the oligomers made from them, when cured, are susceptible to oxidation.

Representative polycarbonate polyols include but are not limited to the reaction products of dialkyl carbonate with an alkylene diol, optionally copolymerized with alkylene ether diols.

The polyisocyanate component (ii) is preferably non-aromatic. Oligomers based on aromatic polyisocyanates cause yellowing in the cured coating. Non-aromatic polyisocyanates of from 4 to 20 carbon atoms may be employed. Suitable saturated aliphatic polyisocyanates include but are not limited to isophorone diisocyanate; dicyclohexylmethane-4,4′-diisocyanate; 1 ,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,9-nonamethylene diisocyanate; 1,10-decamethylene diisocyanate; 2,2,4-trimethyl-1,5-pentamethylene diisocyanate; 2,2-dimethyl-1,5-pentamethylene diisocyanate; 3-methoxy-1,6-hexamethylene diisocyanate; 3-butoxy-1,6-hexamethylene diisocyanate; omega, omega′-dipropylether diisocyanate; 1,4-cyclohexyl diisocyanate; 1,3-cyclohexyl diisocyanate; trimethylhexamethylene diisocyanate; 1,3-bis(isocyanatomethyl) cyclohexane; 1,4-diisocyanato-butane; biuret of hexamethylene diisocyanate; norbornane diisocyanatomethyl 2,5(6)-bis(isocyanatomethyl)bicyclo (2,2,1) heptane; and mixtures thereof.

Isophorone diisocyanate is a preferred aliphatic polyisocyanate. Suitable (though less preferred) aromatic polyisocyanates include toluene diisocyanate; diphenylmethylene diisocyanate; tetramethyl xylene diisocyanate; 1,3-bis(isocyanatomethyl) benzene; p,m-phenylene diisocyanate; 4,4′-diphenylmethane diisocyanate; dianisidine diisocyanate (i.e., 4,4′-diisocyanato-3,3′-dimethoxy-1,1′-biphenyl diisocyanate); tolidine diisocyanate (i.e., 4,4′-diisocyanato-3,3′-dimethy-1,1′-biphenyl diisocyanate); and mixtures thereof. Of the aromatic polyisocyanates, toluene diisocyanate is preferred. Very small amounts of aromatic polyisocyanates may be used. However, long term stability after aging may suffer somewhat.

The catalyst, if present, is present in any of the conventional and known catalytically effective amounts sufficient to carry out the urethane synthesis. Suitable catalysts include but are not limited to dibutyl tin dilaurate, dibutyl tin oxide, dibutyl tin di-2-hexoate, stannous oleate, stannous octoate, lead octoate, ferrous acetoacetate, and amines such as triethylamine, diethylmethylamine, triethylenediamine, dimethylethylamine, morpholine, N-ethyl morpholine, piperazine, N,N-dimethyl benzylamine, N,N-dimethyl laurylamine, and mixtures thereof.

The endcapping monomer (iii) may be one which is capable of providing at least one reactive terminus. Suitable hydroxyl-terminated compounds which may be used as the endcapping monomers include, but are not limited to, hydroxyalkyl acrylates or methacrylates. Systems analogous to the acrylate-based compounds, but bearing any reactive end groups, are equally suitable. Various other exemplary end groups capable of reacting upon irradiation or other means, either by free radical initiation or cationic cure, to provide excellent performance coatings include, but are by no means limited to, free radical systems such as thiolene systems (based on the reaction of multifunctional thiols and unsaturated polyenes, such as vinyl ethers; vinyl sulfides; allylic ethers and bicyclicenes); amine-ene systems (based on the reaction of multifunctional amines and unsaturated polyenes); acetylenic systems; systems wherein the reactive portion of the component is internal rather than terminal; other vinylic (e.g., styrenic) systems; acrylamide systems; allylic systems; itaconate systems and crotonate systems; and cationic cure systems such as onium salt-induced vinyl ether systems and epoxy-terminated systems which react by ring-opening; and any others based on compounds possessing reactive termini. In fact, virtually any end groups which cure by irradiation or other means but do not adversely effect the desirable properties (i.e., the oxidative, thermal and hydrolytic stability and the moisture resistance) of the cured composition are envisioned. The analogous systems are further disclosed by U.S. Pat. No. 5,352,712 to Shustack, incorporated herein by reference in its entirety.

Typical acrylates and methacrylates include hydroxyethyl acrylate, hydroxyethyl methacrylate, hydroxypropyl acrylate, hydroxypropyl methacrylate, hydroxybutyl acrylate, hydroxybutyl methacrylate, and so forth. A particularly preferred endcapping monomer is hydroxyethyl acrylate or hydroxyethyl methacrylate. The molar ratio of the polyol, diisocyanate and endcapping monomer is preferably approximately 1:2:2.

Commercially available oligomers are suitable for the urethane oligomer component of this invention so long as the cured coating material made therefrom meets the appropriate standards for peel back force, percent elongation to break, and tensile strength. By routine testing based on teachings disclosed in this specification, one skilled in the art would test the cured material for such required criteria. Potential resins include but are not limited to the following.

1. ECHO RESINS ALU-350 series resins, i.e., 350, 351, 352, 353 and 354, from Echo Resins and Laboratory, Versailles, Mo., are polytetramethylene polyol-based acrylated aliphatic urethane oligomers of increasing molecular weight and viscosity and decreasing modulus with increasing number in the series. Certain physical properties for this series of resins are summarized in TABLE 1:

TABLE 1

| | ALU-350 | ALU-351 | ALU-352 | ALU-353 | ALU-354 |
|---|---|---|---|---|---|
| Density @ 20° C. (g/cm³) | 1.052 | 1.048 | 1.027 | 1.019 | 1.019 |
| (lbs/gal) | 8.76 | 8.73 | 8.55 | 8.49 | 8.49 |
| Refractive Index | 1.496 | 1.492 | 1.478 | 1.468 | 1.460 |
| Viscosity @ 78° F. (cps) | 320,000 | 120,000 | wax | wax | wax |
| @ 140° F. (cps) | 7,300 | 5,400 | 8,900 | 21,750 | 30,000-40,000 |
| Color, Gardner | <1 | <1 | <1 | <1 | <2 |
| Functionality | 2 | 2 | 2 | 2 | 2 |
| Percent Shrinkage, Cured | 3.6 | 2.8 | 1.7 | 1.3 | 1.1 |
| Number Average | 1,390 | 1,410 | 2,300 | 3,550 | 4,880 |
| Molecular Weight (VPO) | | | | | |

For these oligomers, number average molecular weight was determined by vapor pressure osmometry (VPO) using a Knauer VPO, calibrated with benzil, tetracosane and polystyrene standards, using toluene as solvent, for 3 minutes at 40° C., zero balance of 9 and range of 8, using a Universal probe.

In general, the lower molecular weight members of the series are preferred because they are less waxy and easier to work with, and because the compositions including them swell less when contacted with solvents which they may encounter.

The methacrylate equivalents of these oligomers are equally suitable.

2. PURELAST aliphatic urethane acrylate oligomers based on polyether backbones, available from Polymer Systems Corporation, Orlando, Fla. Suitable PURELAST oligomers include 566, 566A, 569, 569A, 569V, 586, 586A, 586V, 590, 590A, 595 and 595A, preferably, 590 and 590A. This series of oligomers increases in modulus with increasing number in the series.

Methacrylate analogs of these oligomers are suitable as well.

3. SARTOMER CN 980 and 981, are both polyether-backbone aliphatic urethane acrylates, also from Sartomer Company, Exton, Pa.

4. BR-372, BR-543, BR-571, BR-582, BR-5824, BR-5825, STC3-149 are polyether-backbone aliphatic urethane acrylates, from Bomar Specialties, Winsted, Conn.

5. RX 01203, RX 01099, RX 01336, RX 01071, RX 01218, IRR 245, EBECRYL 8800, EBECRYL 270, and EBECRYL 4826 oligomers, are from UCB Chemicals Corporation, Smyrna, Ga., all aliphatic urethane diacrylate oligomers based on polyethers.

EBECRYL 8800 oligomer is diluted 10% with ethoxyethoxyethyl acrylate; has a viscosity at 65° C. of 8,000-18,000 cps and a Gardner Color Index of 2 max. Its density is 8.75 pounds per gallon. Its theoretical molecular weight is 1,700. When cured it has a tensile strength of 3,150 psi; a tensile elongation of 83%, and a glass transition temperature of 48° C.

EBECRYL 270 oligomer, previously sold as EBECRYL 4826 oligomer; has a viscosity of 2,500-3,500 cps at 60° C. and a Gardner Color Index of 2 max. Its density is 8.91 pounds per gallon. Its theoretical functionality is 2 and its theoretical molecular weight is 1,500. When cured it has a tensile strength of 1,200 psi, a tensile elongation of 87%.

Methacrylate equivalents of these oligomers may also be used.

6. UVITHANE ZL-1 178 oligomer from Morton Thiokol, Inc., Morton Chemical Division, Princeton, N.J., polyether based aliphatic urethane acrylate. This oligomer has a viscosity of 55-75 poises at 120° F. and 700-800 poises at 78° F. and, when cured neat, has a tensile strength of 325 psi and an ultimate elongation of 45%.

The methacrylate analog of this monomer may be used as well.

7. EBECRYL 4842, which is a silicone-modified polyether-based aliphatic urethane acrylate, sold neat, and EBECRYL 19-6264, which is not silicone-modified, but which is a polyether-based aliphatic urethane acrylate and which contains about 15% by weight of 1,6-hexanediol diacrylate as a reactive solvent, are from UCB Chemicals Corporation, Smyrna, Ga.

8. Hydrocarbon polyol-based aliphatic urethane acrylate oligomers such as are disclosed in U.S. Pat. No. 5,146,531, to Shustack. The content of that patent is expressly incorporated herein by reference. These oligomers are based on a linear or branched hydrocarbon polymer of from 600 to 4,000 molecular weight such as fully or partially hydrogenated 1,2-polybutadiene; 1,2-polybutadiene hydrogenated to an iodine number of from 9 to 21; and fully or partially hydrogenated polyisobutylene.

9. Polyether polyol-based oligomer of U.S. Pat. No. 5,527,835 to Shustack is also acceptable for use in making coating and is incorporated herein by reference in its entirety.

10. Furthermore, any aliphatic urethane acrylate oligomer of the type exemplified above is believed to be suitable so long as the desirable properties of the claimed fibers, coatings, methods and compositions are not adversely affected.

B. Acrylate Di-Terminated Diphenylmethane Polyol Oligomer

One additional class of potential oligomers is the class of polyol oligomers which are the diglycidyl ether reaction products of bisphenols and halohydrins which are acrylate di-terminated, polyhydroxylated and contain diphenylmethane groups. The coating composition may comprise 0 to about 50 weight percent of one or more of these polyol oligomers.

The polyol oligomers are preferably derived from bisphenol diglycidyl ethers, which are preferably the reaction product of a halohydrin and a bisphenol, more preferably bisphenol A. This reaction product is then polyacrylated to form a polyfunctional acrylate di-terminated diphenylmethane polyol. Preferably, the polyol is substituted with at least two hydroxys, more preferably with at least three and with at least one of them a few atoms inside of each acrylate terminus. Still more preferably, the methane of the diphenylmethane has two methyl substituents and one of the phenyls of the diphenylmethane is about 0 to about 3 atoms away from an ester or partially saturated ester group.

For example, the compound having Formula II below is a diglycidyl ether reaction product of a bisphenol and a halohydrin:

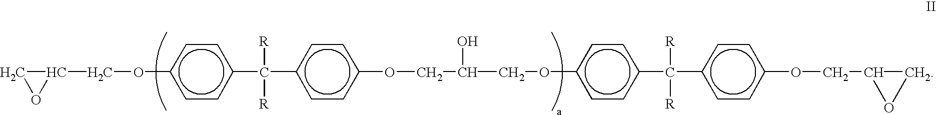

In Formula II, a is 0 to 4, preferably 0.5 to 3, typically 0, 1, 2, 3 or 4, R is hydrogen, methyl or linear or branched lower alkyl having 1 to about 6 carbon atoms, typically 1 to 4 carbon atoms, e.g., 1 or 2 carbon atoms. Examples of R include methyl, ethyl, propyl, isopropyl, butyl, isobutyl, tert-butyl, pentyl, isopentyl, hexyl and the like and the R on one side may be the same or different from the R opposite. Typically, one or each R is methyl.

Typical acrylates and methacrylates, which may endcap the oligomer, include hydroxyethyl acrylate, hydroxyethyl methacrylate, hydroxypropyl acrylate, hydroxypropyl methacrylate, hydroxybutyl acrylate, hydroxybutyl methacrylate, and so forth. A preferred endcapping acrylate group is hydroxyethyl acrylate.

When reacted with a reactive moiety selected from the group consisting of acrylic, methacrylic, vinylic, allylic, styrenic, acrylamide, norbornenyl, acetylenic, epoxy, mercapto, amino, itanoic and crotonic moieties this compound may form an exemplary epoxy oligomer of the present invention, as depicted by Formula III. Suitable endcapping R′ moieties also include those discussed above for the encapping monomer (iii) of the urethane oligomer.

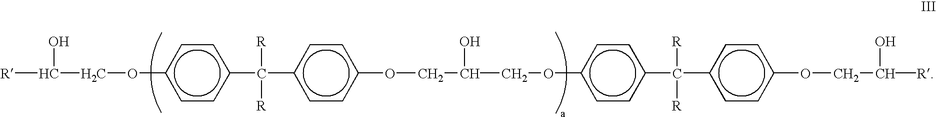

When acrylated with CH₂CHCOO— at each termini, this compound may form an exemplary epoxy oligomer of the present invention, as depicted by Formula MA below:

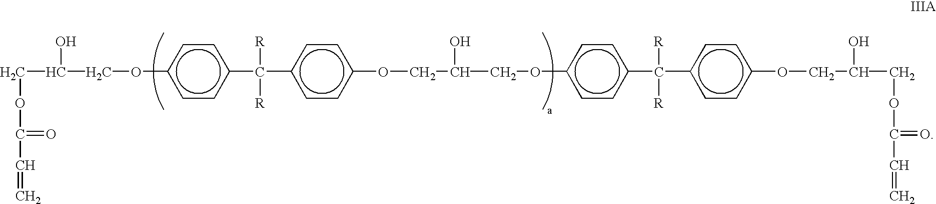

In Formula III R′ is a reactive moiety independently selected from the group consisting of acrylic, methacrylic, vinylic, allylic, styrenic, acrylamide, norbornenyl, acetylenic, epoxy, mercapto, amino, itanoic and crotonic moieties. Suitable endcapping R′ moieties also include those discussed above for the encapping monomer (iii) of the urethane oligomer. In both Formulas III and IIIa, a is 0 to 4, preferably 0.5 to 3, typically 0, 1, 2, 3 or 4, and R is hydrogen, methyl or linear or branched lower alkyl having 1 to about 6 carbon atoms, typically 1 to 4 carbon atoms, e.g., 1 or 2 carbon atoms. Examples of R include methyl, ethyl, propyl, isopropyl, butyl, isobutyl, tert-butyl, pentyl, isopentyl, hexyl and the like and the R on one side may be the same or different from the R opposite. Typically, one or each R is methyl.

Further examples of, and methods of preparing, bisphenol diglycidyl ethers are disclosed in U.S. Pat. No. 5,075,356 to Crosby et al, entitled Bisephenol and Neopentyl Glycol Diglycidyl Ethers with Glycidyl Methacrylate Copolymer; U.S. Pat. No. 6,048,956 to Muto et al, entitled Diglycidyl Ethers; U.S. Pat. No. 4,255,302 to Adams et al, entitled Resin System for Filament Winding of Pressure Vessels; U.S. Pat. No. 4,101,693 to Tsen et al entitled Method of Preparing Epoxy-Glass Prepegs; and U.S. Pat. No. 4,309,473 to Minamisawa et al, entitled Non-Tacky Strand Prepeg Comprising a Resin Composition. Adams et al and Tsen et al specifically disclose diglycidyl ethers that are the reaction product of bisphenol A and epichlorohydrin. Each of the foregoing patents is incorporated herein by reference in its entirety. Bisphenol A diglycidyl ether is also commercially available as EPICOAT 828 (Yuka Shell Epoxy Co. Ltd.) and DER 332.RTM resin (Hi-Tek Polymers) and XU71790.04L (Dow Chemical Company).

II. Reactive Diluent Monomer

The typical function of the second component (reactive diluent) is to dilute the other oligomers to reduce their viscosity so that the liquid mixture may be smoothly applied to an optical fiber. The monomer diluent component should be reactive with the above-described oligomers, and preferably has one or more acrylate or methacrylate moieties per monomer. The monomer diluent may be capable of lowering the Tg (glass transition temperature) of the cured composition including it, and of lowering the viscosity of the uncured (liquid) composition to within the range of about 1,000 to about 10,000 cps (centipoises) at 25° C., preferably about 4,000 to about 8,000 cps, as measured by a Brookfield viscometer, Model LVT, spindle #34, at 25° C. If a viscosity higher than about 10,000 cps results, the liquid (uncured) composition including it may still be useful if certain processing modifications are effected (e.g., heating the dies through which the liquid coating composition is applied).

The monomer diluent, if present, comprises about 5 to about 95 percent, preferably about 10 to about 80 percent, more preferably about 15 to about 70 percent, and most preferably about 20 to about 65 percent by weight of the uncured (liquid) composition, based on the total weight of the composition (all ingredients).

Suitable examples of monomer diluents include, but are not limited to, aromatic-containing monomers such as phenoxyalkyl acrylates or methacrylates (e.g., phenoxyethyl(meth)acrylate); phenoxyalkyl alkoxylate acrylates or methacrylates (e.g., phenoxyethyl ethoxylate(meth)acrylate or phenoxyethyl propoxylate(meth)acrylate); para-cumylphenol ethoxylated (meth)acrylate; 3-acryloyloxypropyl-2-N-phenylcarbamate; or one of any other such monomer diluents known to adjust the refractive index of a composition including it. Combinations including one or more of these are suitable as well. Such monomer diluents belonging to the later category are disclosed and described in U.S. Pat. No. 5,146,531 to Shustack herein incorporated by reference and may, for example, contain (1) an aromatic moiety; (2) a moiety providing a reactive (e.g., acrylic or methacrylic) group; and (3) a hydrocarbon moiety.

Samples of aromatic monomer diluents additionally containing hydrocarbon character and a vinyl group include but are not limited to polyalkylene glycol nonylphenylether acrylates such as polyethylene glycol nonylphenylether acrylate or polypropylene glycol nonylphenylether acrylate; polyalkylene glycol nonylphenylether methacrylates such as polyethylene glycol nonylphenylether methacrylate or polypropylene glycol nonylphenylether methacrylate; and mixtures of these.

Such monomers are, for example, available from Sartomer Co., Exton, Pa., under the trade names CD613, CD614 and SR504, available from Toagasei Chemical Industry Company, Ltd., Tokyo, Japan under the trade names ARONIX M110, M111, M113, M114, and M117, and from Henkel Corporation, Ambler, Pa., under the trade name PHOTOMER 4003. Especially M117 (or CD614), i.e., nonyl phenol 1.5 (PO) acrylate is preferred.

Other suitable monomer diluents additionally include hydrocarbon alkyl acrylates or methacrylates which are either straight chain or branched, and may contain 8 to 18 carbon atoms in the alkyl moiety such as hexyl acrylate; hexyl methacrylate; ethylhexyl acrylate; ethylhexyl methacrylate; isooctyl acrylate; isooctyl methacrylate; octyl acrylate; octyl methacrylate; decyl acrylate; decyl methacrylate; isodecyl acrylate; isodecyl methacrylate; lauryl acrylate; lauryl methacrylate; tridecyl acrylate; tridecyl methacrylate; myristyl acrylate; myristyl methacrylate; palmitic acrylate; palmitic methacrylate; stearyl acrylate; stearyl methacrylate; cetyl acrylate; cetyl methacrylate; C12-C18 hydrocarbon diol diacrylates; C12-C18 hydrocarbon diol dimethacrylates; and mixtures of the above. Tridecyl, cetyl, lauryl and stearyl acrylates or methacrylates are most desired.

Also suitable are cyclic monomers such as isobornyl acrylate; isobornyl methacrylate; dicyclopentenyl acrylate; dicyclopentenyl methacrylate; dicyclopentenyl ethoxylate acrylate; dicyclopentenyl ethoxylate methacrylate; tetrahydrofurfuryl acrylate; tetrahydrofurfiryl methacrylate; and mixtures thereof. Also suitable is TONE M-100 monomer, a caprolactone acrylate available from Union Carbide Corp., Danbury, Conn., GENORAD 1122 monomer available from Hans Rahn, Zurich, Switzerland, which is 2-propenoic acid, 2-(((butyl)amino)carbonyloxy)ethylester, and N-vinyl caprolactam.

Preferred monomers include the refractive-index modifying type monomers as disclosed herein, alone or in combination with an alkyl (meth)acrylate such as lauryl acrylate.

III. Adhesion Promoter

Adhesion promoters assist in maintaining contact of the coating to the glass fiber. Adhesion is a particularly pertinent problem in high humidity and high temperature environments, where delamination of the coating from the glass fiber is more of a risk.

A. Bis-silyl Amines

The bis-silyl adhesion promoters have a Formula I:

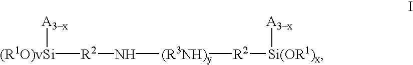

wherein each R¹ is independently C1-C4 alkyl, preferably C1 or C2 alkyl;

wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;

each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;

each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;

X is 1 to 3;

V is 1 to 3; and

Y is 0 to 1,

with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than trimethoxysilylpropyl amine, diacrylated silane tertiary amine, acetoxy functional silanes, and trifunctional isocyanurates.

Typically, when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than trimethoxysilylpropyl amine, diacrylated silane tertiary amine, acetoxy functional silanes, and trifunctional isocyanurates other than tris[(trimethoxysilyl)propyl]-isocyanurate.

Bis(trimethoxysilyl)propylamine has the formula (CH₃O)₃SiCH₂CH₂CH₂—NH—CH₂CH₂CH₂Si(OCH₃)₃ and information on this compound is presented in TABLE 2.

TABLE 2

| Compound (CAS#) | Structure | Suppliers |
|---|---|---|
| Bis(trimethoxysilyl) | (CH₃O)₃SiCH₂CH₂CH₂—NH— | Gelest |
| propylamine | CH₂CH₂CH₂Si(OCH₃)₃ | (SIB1833.0) |
| (82985-35-1) | | |

The coating layer may contains about 0.05 to about 30, typically about 0.1 to about 10, or about 0.2 to about 5, weight percent one or more bis-silyl amine adhesion promoters, based on total weight of all ingredients.

Typically, the primary coating layer contains from about 0.05 to about 5.0, for example from about 0.1 to about 3.0, or from about 0.2 to about 1.0, weight percent of one or more bis-silyl amine adhesion promoters based on the total weight of all ingredients.

B. Diacrylated Tertiary Amine Silanes

A family of diacrylated tertiary amine silanes has the following Formula IV.

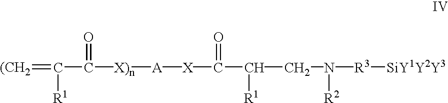

wherein R¹ is H or CH₃; n is 1 to 2; A is a bivalent linking group; X is O, S, NH; R² is H or a C1-C20 organic group; R3 is a divalent linking group; and each of Y¹ Y² Y³ which may be the same or different, represents alkoxyl, carboxy alkoxy ether, alkyl or aryl. Methods of making these compounds are disclosed in published Patent Cooperation Treaty application no. WO 98/28307 incorporated herein by reference. In general, these compounds may be made by reacting a multifunctional (meth)acrylate of formula (V) with a silane of formula VI:

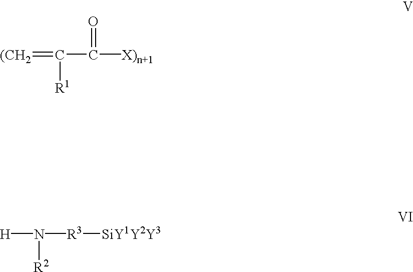

The coating layer may contain about 0.05 to about 30, typically about 0.1 to about 10, or about 0.2 to about 5, weight percent one or more diacrylated tertiary amine silanes adhesion promoters, based on total weight of all ingredients.

Typically, the primary coating layer contains from about 0.05 to about 5.0, for example from about 0.1 to about 3.0, or from about 0.2 to about 1.0, weight percent of one or more diacrylated tertiary amine silanes adhesion promoters based on the total weight of all ingredients.

The diacrylated tertiary amine silanes may include the amine listed in TABLE 3.

TABLE 3

| Compound (CAS#) | Structure | Suppliers |
|---|---|---|
| Diacrylated silane based | Proprietary | Sartomer |
| on tertiary amine | | (NTX4456) |

If desired, the amines of Formula IV, e.g., Sartomer (NTX4456 diacrylated tertiary amine silane), may be used in the presence or absence of the bis-silyl amines.

C. Acetoxy Functional Silanes

Another class of adhesion promoters are acetoxy functional silanes. If desired the acetoxy functional silanes may be used in the presence or absence of the bis-silyl amines.

Typical acetoxy functional silanes have the Formula VII.

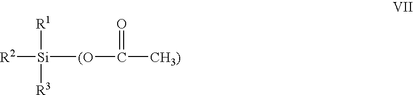

wherein R¹ and R² are independently selected from the group consisting of

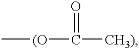

H, C1-C4 alkyl, phenyl, cyclohexyl, CH₂═CH₂, acrylate and C1-C4 alkoxy; and

R³ is independently selected from the group consisting of C1-C4 alkyl, phenyl, cyclohexyl, CH₂═CH₂, acrylate and C1-C4 alkoxy. Unexpectedly it has been found that certain compounds of Formula VII are attractive adhesion promoters yet do not have free radical reaction with the radiation curable pre-polymer, namely those wherein R¹, R² and R³ do not contain a carbon to carbon double bond.

The coating layer may contain about 0.05 to about 30, typically about 0.1 to about 10, or about 0.2 to about 5, weight percent one or more acetoxy functional silanes adhesion promoters, based on total weight of all ingredients.

Typically, the primary coating layer contains from about 0.05 to about 5.0, for example from about 0.1 to about 3.0, or from about 0.2 to about 1.0, weight percent of one or more acetoxy functional silanes adhesion promoters based on the total weight of all ingredients.

A number of typical acetoxy functional silanes are shown in TABLE 4.

TABLE 4

| Compound (CAS#) | Structure | Suppliers |
|---|---|---|
| Vinyltriacetoxy- silane (4130-08-9) | 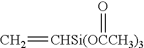 | Dow Corning (Z-6075), Gelest (SIV9098.0) |
| Dimethyldiacetoxy- silane (2182-66-3) | 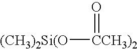 | Gelest (SID4076.0) |
| Vinylmethyl- diacetoxysilane (5356-85-4) | 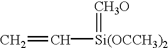 | Gelest (SIV9083.0) |
| Methyltriacetoxy- silane (4253-34-3) | 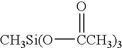 | Gelest (SIM6519.0) |

Additional typical acetoxy functional silanes are shown as follows:

DI-t-BUTOXYDIACETOXYSILANE

(Me₃ CO)Si(OCOCH₃)₂

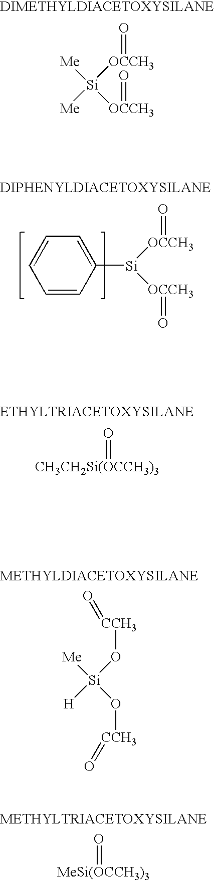

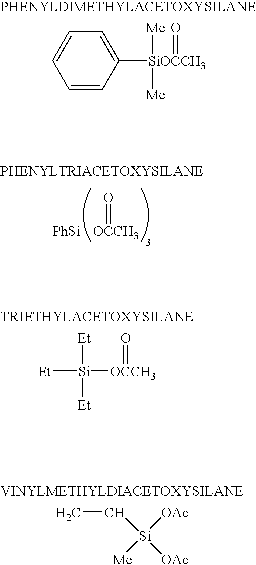

D. Trifunctional Isocyanurate Silanes

Another class of additional adhesion promoters are the trifunctional isocyanurates having a heterocyclic ring of 3 carbon atoms alternating with 3 nitrogen atoms, wherein each nitrogen atom is substituted with an R⁵ group and each R⁵ is independently selected from the group consisting of C1-C6 alkyl (typically C1, C2, C3 or C4 alkyl), vinyl, acetoxy, meth(acrylate), phenyl, cycloalkanes, and bis-phenyol A radical, and

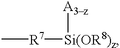

wherein R⁷ is C1-C6 alkyl, for example C3, C4, C5 or C6, R⁸ is C1-C4 alkyl, for example, C3 or C4, and Z is 1, 2 or 3, wherein at least one R⁵ is —R⁷-Si(OR⁸)_{z}, and each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;

with the proviso that when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines, diacrylated silane tertiary amine, acetoxy functional silanes, trifunctional isocyanurates other than tris[(trimethoxysilyl)propyl]-isocyanurate.

Typically, when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines other than bis(trimethoxysilyl)propylamine, diacrylated silane tertiary amine, acetoxy functional silanes, trifunctional isocyanurates other than tris[(trimethoxysilyl)propyl]-isocyanurate.

The coating layer may contain about 0.05 to about 30, typically about 0.1 to about 10, or about 0.2 to about 5, weight percent one or more trifunctional isocyanurate silane adhesion promoters, based on total weight of all ingredients.

Typically, the primary coating layer contains from about 0.05 to about 5.0, for example from about 0.1 to about 3.0, or from about 0.2 to about 1.0, weight percent of one or more trifunctional isocyanurate silane adhesion promoters based on the total weight of all ingredients.

An example of a trifunctional isocyanurate is tris[(trimethoxysilyl)propyl]-isocyanurate, having 3 identical R⁵ groups in which R⁷ is C3 alkyl, and R⁸ is methyl.

A typical trifunctional silane is shown in TABLE 5.

TABLE 5

| Compound | Structure | Supplier |
|---|---|---|
| Tris[(trimethoxysilyl) propyl]-isocyanurate | 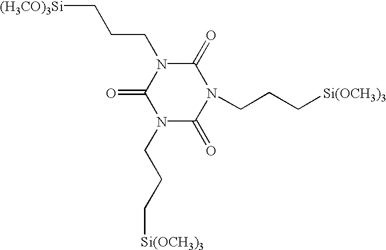 | Crompton (Y-11597) |

E. Adhesion Promoters Which Do Not Undergo Free Radical Reaction

Surprisingly, it has been discovered that silanes which did not couple with the coating polymer backbone could be useful for improving adhesion to glass. The conventional understanding for adhesion promoters was that one end of the coupling agent, the silanol group, would react with the glass and the other functional group of the coupling agent should react with the polymer matrix, hence the use of mercapto-, acrylo-, or methacrylo- silanes in prior art. For example, the compounds of Formula I, such as, bis(trimethoxysilyl)propylamine, would not be expected to have a free-radical reaction with the pre-polymer because they have no free radical polymerizable groups. Also, dimethyldiacetoxy silane, epoxy functional silanes, and tris[(trimethoxysilyl)propyl]-isocyanurate and mixtures thereof would not be expected to have a free-radical reaction with the pre-polymer because they have no free radical polymerizable groups. Unexpectedly it has been found that certain acetoxy functional silane compounds of Formula VII are attractive adhesion promoters yet do not have free radical reaction with the radiation curable pre-polymer, namely those wherein R¹, R² and R³ do not contain a carbon to carbon double bond.

F. Optional Additional Adhesion Promoters

In addition there may further be included other either acid-functional materials or organofunctional silanes to promote adhesion of resins to glass.

The total of the one or more additional silane components, if present, comprises from about 0.01 percent to about 10.0 percent by weight of the ingredients, based on total weight of all ingredients. For example, the additional silane comprises from about 0.05 percent to about 5.0 percent, or from about 0.1 percent to about 3.0 percent, based on the total weight of the ingredients.

These additional adhesion promoters are typically silanes having a functionality which binds in with the system during cure, again to minimize the quantities of unbound volatiles. Various suitable organofunctional silanes include but are not limited to acrylate-functional silanes; amino-functional silanes; mercapto-functional silanes; methacrylate-functional silanes; acrylamido-functional silanes; allyl-functional silanes; and vinyl-functional silanes. The adhesion promoters preferably are methoxy- or ethoxy-substituted as well. Preferred organofunctional silanes include but are not limited to mercaptoalkyl trialkoxy silane, (meth)acryloxyalkyl trialkoxy silane, aminoalkyl trialkoxy silane, mixtures thereof, and the like. Methacrylated silanes are desirable, because they bind well with the cured system. However, they tend to slow the cure speed of the system. The mercapto-functional adhesion promoters also chemically bind in during cure, and appreciably slow down the cure speed of the system.

Some preferred additional organofunctional silanes that enhance adhesion in humid conditions include 3-acryloxypropyltrimethoxy silane, vinyl-tris(2-methoxyethoxysilane), 3-methacryloxypropyltrimethoxy silane, 3-aminopropyltriethoxy silane, 3-mercaptopropyl trimethoxy silane and 3-mercaptopropyl triethoxy silane, and mixtures thereof. A particularly preferred adhesion promoter is 3-acryloxypropyltrimethoxy silane.

Another optional adhesion promoter is shown in TABLE 6.

TABLE 6

| Compound (CAS#) | Structure | Suppliers |
|---|---|---|
| N-2- (Vinylbenzylamino)- ethyl-3-aminopropyl- trimethoxysilane·monohydrogen chloride (34937-00-3) | 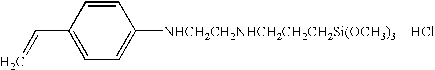 | Dow Corning (Z-6032) |

IV. Photoinitiator

The necessity for this component depends on the envisioned mode of curing. If ultraviolet, a photoinitiator is needed. If by an electron beam, the material may comprise substantially no photoinitiator.

The photoinitiator, when used in a coating, preferably comprises from about 0.3 percent to about 10 percent by weight of the uncured mixture, based upon the weight of the total mixture. Preferably, the amount of photoinitiator is from about 1 percent to about 5 percent.

In the ultraviolet cure embodiment, the photoinitiator must provide reasonable cure speed without causing premature gelation of the mixed ingredients. Further, it must not interfere with the optical clarity of the cured coating. Still further, the photoinitiator must itself be thermally stable, non-yellowing, and efficient.

Suitable photoinitiators include, but are not limited to, the following: hydroxycyclohexylphenyl ketone; hydroxymethyl-phenylpropanone; dimethoxyphenylacetophenone; 2-methyl-1-(4-methyl (thio)phenyl)-2-morpholino-propanone-1; 1-(4-isopropylphenyl)-2-hydroxy-2-methylpropan-1-one; 1(4-dodecylphenyl)-2-hydroxy-2-methylpropan-1-one; 4-(2-hydroxyethoxy)phenyl-(2-hydroxy-2-propyl)ketone; diethoxyacetophenone; 2,2-di-sec-butoxyacetophenone; diethoxy-phenyl acetophenone; and mixtures of these.

A preferred class of photoinitiators are the phosphine oxides, such as trimethylbenzoyldiphenyl-phosphine oxide (available from BASF Corp., Chemicals Division, Charlotte, N.C. as LUCIRIN TPO), trimethylbenzoylethoxyphenylphosphine oxide (available from BASF as LUCIRIN 8893); bis-(2,6-dimethoxybenzoyl)-2,4,4-trimethylpentyl phosphine oxide, and bis-(2,4,6-trimethylbenzoyl)-phenyl phosphine oxide (CGI 819) or bis-(2,6-dimethoxybenzoyl)-2,4,4-trimethyl pentyl phosphine oxide (sold as a component of CGI 1700 or CGI 1800) all available from Ciba Specialty Chemical, Ardsley, N.Y.

Any of the acceptable photoinitiators disclosed above are suitable. However, a lower level of photoinitiator is generally desirable in the secondary coating relative to the coating. The reason is that to cure the coating through the secondary coating, there must not be too much photoinitiator in the secondary coating blocking the light, as can occur where the coatings are applied wet-on-wet and then simultaneously cured.

V. Other Optional Additives

To improve shelf life (storage stability) of the uncured coating mixture, as well as to increase thermal and oxidative stability of the cured coating layer, one or more stabilizers may be added.

When a stabilizer is used, it may be incorporated in an amount from about 0.0001 to about 10 percent, preferably from about 0.0001 to about 3.0, weight percent, based on the total weight of the mixture. More preferably, it is included in the range from about 0.1 to about 2.0 weight percent, and furthermore preferably in the range from about 0.5 to about 1.5 weight percent, based on the total weight of all of the ingredients. Preferred stabilizers are thiodiethylene bis (3,5-di-tert-butyl-4-hydroxy) hydrocinnamate and 3-aminopropyl trimethoxysilane.

Examples of suitable stabilizers include tertiary amines such as diethylethanolamine and trihexylamine, hindered amines, organic phosphates, hindered phenols, mixture thereof, and the like. Some particular examples of antioxidants which can be used include octadecyl-3-(3′,5′-di-tert-butyl-4′-hydroxyphenyl) propionate, thiodiethylene bis (3,5-di-tert-butyl-4-hydroxy) hydrocinnamate, and tetrakis (methylene (3,5-di-tert-butyl-4-hydroxyhydrocinnamate)) methane. Additionally, certain silanes in small quantities, e.g., as low as 0.0001 percent to 0.1 percent by weight, may be used as stabilizers. An example of suitable such silane is 3-aminopropyl trimethoxy silane.

Another optional additive for the secondary coating is a surface tension adjusting silicone additive, which may be used in embodiments where a secondary coating is to be applied atop a cured primary coating.

Other optional additives include light sensitive and light absorbing components, catalysts, lubricants, inhibitors, wetting agents, antioxidants, pigments and/or dyes.

### Preparation of a Coated Optical Fiber

The invention also relates to a process for preparing a coated optical fiber. The process comprises applying to an optical glass fiber a coating reaction mixture comprising the coating ingredients, in their respective amounts, as described in the foregoing pages. Typically, those ingredients include the following:

(I) about 5 to 95 percent, preferably 10 to about 90 percent, by weight of one or more oligomers;

(II) optionally, about 5 to about 95 percent by weight of a reactive diluent;

(III) about 0.05 to about 30 percent, for example about 0.1 to about 10 or about 0.2 to about 5 percent or about 0.2 to about 3 percent, of at least one adhesion promoter selected from the group consisting of bis-silyl amines, diacrylated silane tertiary amine, acetoxy functional silanes, trifunctional isocyanurates and mixtures thereof, as described above, with the provisos that

A. when the adhesion promoter contains trimethoxysilylpropyl amine the coating composition (i) is free of oligomer having a saturated aliphatic backbone between at least two of the terminal ends with at least one epoxide group and/or (ii) comprises at least one adhesion promoter selected from the group consisting of a bis-silyl amines other than trimethoxysilylpropyl amine, diacrylated silane tertiary amine, acetoxy functional silanes, and trifunctional isocyanurates, and

B. when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines, diacrylated silane tertiary amine, acetoxy functional silanes, trifunctional isocyanurates other than tris[(trimethoxysilyl)propyl]-isocyanurate;

(IV) 0 to about 10 percent of a photoinitiator; and

(V) 0 to about 10 percent of one or more additives such as light sensitive and light absorbing components, catalysts, lubricants, inhibitors, wetting agents, antioxidants, stabilizers, pigments and dyes or other additives, wherein all percents are by weight of the coating reaction mixture.

Typically,

A. when the adhesion promoter contains trimethoxysilylpropyl amine the coating composition (i) is free of oligomer having a saturated aliphatic backbone between at least two of the terminal ends with at least one epoxide group and/or (ii) comprises at least one adhesion promoter selected from the group consisting of a bis-silyl amines other than trimethoxysilylpropyl amine, diacrylated silane tertiary amine, acetoxy functional silanes, and trifunctional isocyanurates other than tris[(trimethoxysilyl)propyl]-isocyanurate, and

B. when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines other than trimethoxysilylpropyl amine, diacrylated silane tertiary amine, acetoxy functional silanes, trifunctional isocyanurates other than tris[(trimethoxysilyl)propyl]-isocyanurate.

Typically, the oligomers comprise a reactively terminated urethane oligomer which is the reaction product of (i) at least one polyol selected from the group consisting of polyether polyols, hydrocarbon polyols, polycarbonate polyols, and polyisocyanate polyols; (ii) a wholly aliphatic polyisocyanate; and (iii) an endcapping monomer supplying a reactive terminus, and, optionally a portion of the one or more oligomers includes a polyol oligomer, said polyol oligomer comprising a bisphenol diglycidyl ether, said diglycidyl ether reaction product being terminated at both ends by an acrylate group capable of reacting with the reactive terminus of component (I).

Preferably, a mixture of the urethane oligomer and the polyol oligomer is liquid at 5 to 25° C. This liquid mixture preferably exhibits good optical clarity, i.e., a UV absorbance when measured at 25° C. and at 500 nm relative to distilled water of less than about 0.04, most preferably less than 0.02.

Typically, the process comprises applying to an optical glass fiber a coating reaction mixture comprising the following ingredients:

(I) about 40 to about 80 weight percent of one or more acrylate- or methacrylate-terminated aliphatic polyether urethane oligomers, and optionally, from about 20 to about 50 weight percent of a polyol oligomer, said polyol oligomer comprising a bisphenol diglycidyl ether, the diglycidyl ether reaction product being terminated at both ends by an acrylate group capable of reacting with the reactive terminus of component (I)

(II) about 20 to about 65 weight percent of a reactive diluent; and

(III) 0.05 to about 30, typically about 0.1 to about 10 or 0.2 to about 5, weight percent of one or more bis-silyl amine adhesion promoters of Formula I.

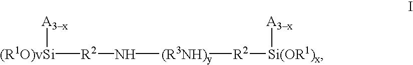

wherein each R¹ is independently C1- C4 alkyl, preferably C1 or C2 alkyl;

wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;

each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C1 2-C 15 substituted or unsubstituted bis-cyclic hydrocarbon, e.g., bis-phenol A radical;

each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;

X is 1 to 3;

V is 1 to 3; and

Y is 0 to 1,

with the provisos that

A. when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates, and

B. when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines, diacrylated silane tertiary amine, acetoxy functional silanes, trifunctional isocyanurates other than tris[(trimethoxysilyl)propyl]-isocyanurate, and

(V) 0 to about 10 weight percent of one or more additives such as light sensitive and light absorbing components, catalysts, lubricants, inhibitors, wetting agents, antioxidants, stabilizers, pigments and dyes, wherein all of these percentages are by weight based on the weight of all the ingredients.

Preferably, the coating ingredients for a primary coating are selected to meet the desired adhesion to glass, as measured by a 180° peel test, high tensile strength, and high elongation to break.

After mixing the ingredients and coating an optical fiber, the coating undergoes radiation-curing in situ. In one embodiment, the process comprises applying only the primary coating to the optical fiber and radiation-curing the coating in situ. In an alternative embodiment, a secondary coating may be applied atop the primary coating, and the two coatings sequentially or simultaneously radiation cured.

The primary and secondary coatings may be applied and cured by any method known in the art. A preferred method, whereby two coatings are applied wet-on-wet, is disclosed in U.S. Pat. No. 4,474,830 to C. Taylor of AT&T Bell Laboratories. The coating or coatings may then be cured in situ, preferably by ultraviolet irradiation, to obtain a cured polymeric coating. Alternatively, the primary coating may be applied and cured, after which the secondary coating may be applied and cured.

When a coated optical fiber is subjected to humid conditions, the adhesion of the coating to the glass fiber may decrease. The adhesion retention, that is the percentage of adhesion remaining under defined humid conditions, as compared with the adhesion under dry conditions, should be high. The coating compositions according to the invention typically show an adhesion retention of at least about 40%, or at least about 50%, or at least about 60%. According to the invention it is even possible to provide coating compositions showing a higher adhesion to glass under humid conditions than under dry conditions, i.e., the adhesion retention can be higher than 100%. However, the increase in adhesion retention should not be so high as to adversely affect stripability. The adhesion retention is measured as described below.

### EXAMPLES

The formulations were mixed in a Hauschild mixer by adding the desired amounts of components. Each of the materials of the formulations were added to a standard basemix. Then the materials were well mixed and applied to glass plates, cured, conditioned at the experimental program time, temperature, and humidity, and then tested for cure speed and adhesion strength.

The base mix includes all the ingredients of the coating except for the adhesion promoter. The base mix composition is shown in TABLE 7.

TABLE 7

| Sequence | | |
|---|---|---|
| of | Raw | Weight |
| Addition | Material | % |
| 1 | RX01336 | 46.72 |
| 2 | I-184 | 2.00 |
| 3 | I-819 | 0.40 |
| 4 | TPO | 0.90 |
| 5 | I-1035 | 1.00 |
| 6 | CD 614 | 19.23 |
| 7 | IBOA | 19.15 |

Cool to <90° F., then add by difference with the mixer running at
low speed.

| | | |
|---|---|---|
| 8 | G-16 | 0.10 |
| 9 | n-VCap | 8.00 |
| Total | | 97.50 |

I. Cure Speed Method

The cure studies were conducted using a Perkin Elmer DSC-7 equipped with an Perkin Ekmer DPA-7 containing a HBO 100 W/2 lamp. A computer activated shutter blade controlled the UV exposure time. The UV radiation passed through UV windows into a temperature controlled oven of Perkin Elmer DSC-7. The sample was placed in an open aluminum pan inside the DSC oven. A constant weight of approximately 3 milligrams was used for each measurement. The oven of the DSC was purged with nitrogen for 5 minutes prior to the testing. The sample temperature was obtained from a thermocouple calibrated for the melting point of indium.

II. Peel Test Method

Three films of the base liquid composition were prepared. Each film was prepared by drawing down the liquid composition on a polished glass plate with a 0.003 Bird. The drawn films on the glass plates were cured by passing the glass plates through a Fusion conveyor system with a Fusion D bulb having an applied dose of 0.7 J/cm2 in an air atmosphere. A secondary coating was drawn over the cured primary coating using a 0.006 Bird and cured with a Fusion D bulb having an applied dose of 0.7 J/cm2.

The cured films were conditioned at room temperature and 50 percent relative humidity for 16 to 24 hours prior to testing unless otherwise indicated. After the conditioning phase, four test specimens were cut from each glass plate. Each test specimens was obtained by placing a 1.00 inch (2.54 cm) wide ruler on the film on a section of the cured film that appeared to be uniform and free of defects. To minimize the effects of minor sample defects, each sample specimen was cut parallel to the direction in which the draw down of the cured film was prepared. Approximately four inches (10.16 cm) were cut on both sides of the ruler was made with a razor blade by holding the blade firmly against the sides of the ruler and cutting completely through the film to the glass plate. The edges of the specimens were inspected for tearing or nicks. Strips that showed such damage were rejected.

Adhesion testing was performed with a calibrated Instron Model 5565 universal testing instrument. The crosshead speed was set to 20.00 mm per minute for a test length of 2.00 inches (5.08 cm). A binder clip was attached to a length of nylon wire, which was run through the pulley on a coefficient of friction (COF) test apparatus. The free end of the nylon wire was clamped in the upper jaw of the Instron testing instrument. The end of each test strip was peeled back about 0.75 inch (1.91 cm) prior to testing. The glass plate was placed on the COF support table with the peeled-back end of the specimen facing away from the pulley. The binder clip was attached to the peeled-back end of the specimen. The Instron test instrument was initiated to pull on the binder clip. Peel force data was collected by computer software.

The obtained data is presented in TABLES 8-15. Each data point was made by making 4 strips in which all 4 strips were subjected to 50% relative humidity for the time listed in the table. The one day test involved subjecting the strips to 50% relative humidity for 16 to 24 hours. Then two of these strips were tested, while the remaining two strips were further subjected to 95% relative humidity for 16 to 24 hours, unlesss otherwise indicated in the table, and then tested.

In the Examples, A-189 is gamma-mercaptopropyltrimethoxysilane, A-174 is gamma-methacryloxypropyltrimethoxysilane, Y-11597 is tris[trimethoxysilyl)propyl]isocyanurate, A-172 is vinyl-tris-(2-methoxyethoxy)silane, and A-187 is gamma-glycidopropyltrimethoxysilane.

TABLE 8

| Material | | 1 | 2 | 3 | 4 | 5 | 6 |
|---|---|---|---|---|---|---|---|
| 408-200 | | 49.00 | 49.00 | 49.00 | 49.00 | 49.00 | 49.00 |
| Z-6075 | | 0.25 | 1.00 | | | — | — |
| NTX-4456 | | — | — | 0.25 | 1.00 | — | — |
| CD9051 | | — | — | — | — | 0.25 | 1.00 |
| 408-200 | | 0.75 | — | 0.75 | — | 0.75 | — |
| Total | | 50.00 | 50.00 | 50.00 | 50.00 | 50.00 | 50.00 |
| Peel | 1 day @ 50% RH | 63.60 | 132.02 | 91.80 | 295.11 | 165.40 | 107.22 |
| Strength | 1 week @ 50% RH | 66.87 | 179.66 | 128.06 | 335.90 | 146.36 | 102.64 |
| (g/in) | 1 week @ 50% RH and | 35.33 | 95.32 | 85.40 | 178.46 | 37.96 | 46.16 |
| | 1 day @ 95% RH | | | | | | |

| | | | | | | |
|---|---|---|---|---|---|---|
| Peel Strength | 52.84 | 53.1 | 66.7 | 53.1 | 25.9 | 45.0 |
| Retention (%) | | | | | | |

Z-6075 is vinyltriacetoxysilane
NTX-4456 is proprietary diacrylated tertiary amine silane from Sartomer
CD9051 is a phosphate ester trimethacrylate
RH is relative humidity

TABLE 9

| Material | | 7 | 8 | 9 | 10 | 11 | 12 | 13 |
|---|---|---|---|---|---|---|---|---|
| 408-200 | | 49.00 | 49.00 | 49.00 | 49.00 | 49.00 | 50.00 | — |
| SIB1833.0 | | 0.25 | 1.00 | — | — | — | — | — |
| SID4076.0 | | — | — | 0.25 | 1.00 | — | — | — |
| A-189 | | — | — | — | — | 0.25 | — | — |
| 408-200 | | 0.75 | — | 0.75 | — | 0.75 | — | — |
| Total | | 50.00 | 50.00 | 50.00 | 50.00 | 50.00 | 50.00 | — |
| Peel Strength | 1 day @ | 241.50 | 424.14 | 78.25 | 123.08 | 124.87 | 61.79 | 97.37 |
| | 50% RH | | | | | | | |
| (g/in) | 1 day @ | 211.93 | 237.83 | 55.88 | 93.64 | 109.99 | 12.85 | 98.48 |
| | 50% RH | | | | | | | |
| | and | | | | | | | |
| | 1 day @ | | | | | | | |
| | 95% RH | | | | | | | |

| | | | | | | | |
|---|---|---|---|---|---|---|---|
| Peel Strength | 87.8 | 56.1 | 71.4 | 76.1 | 88.1 | 20.8 | 101.1 |
| Retention (%) | | | | | | | |

TABLE 10

| Material | | 14 | 15 | 16 | 17 |
|---|---|---|---|---|---|
| 408-200 | | 49.34 | 49.34 | — | — |
| Z-6075 | | 0.33 | 0.33 | — | — |
| SID2780 | | 0.33 | — | — | — |
| SIB1833 | | — | 0.33 | — | — |
| Total | | 50.00 | 50.00 | — | — |
| Peel | 50% RH 2 days | 127.96 | 422.83 | 55.63 | 79.14 |
| Strength | 50% RH 1 wk | 141.01 | 490.73 | 64.92 | 110.51 |
| (g/in) | 50% RH 1 wk | 109.22 | 358.55 | 30.08 | 79.90 |
| | 95% RH 1 day | | | | |

| | | | | |
|---|---|---|---|---|
| Peel Strength Retention | 77.5 | 73.1 | 46.3 | 72.3 |
| (%) | | | | |

TABLE 11

| Material | | 18 | 19 | 20 | 21 | 22 | 23 (Control) |
|---|---|---|---|---|---|---|---|
| 408-200 | | 99.00 | 99.90 | 99.75 | 99.50 | 98.48 | 100.00 |
| A-189 | | 1.00 | — | — | — | 0.49 | — |
| SIB1833.0 | | — | 0.10 | 0.25 | 0.50 | — | — |
| A-174 | | — | — | — | — | 0.75 | — |
| A-187 | | — | — | — | — | 0.23 | — |
| Y-11597 | | — | — | — | — | 0.05 | — |
| Total | | 100.00 | 100.00 | 100.00 | 100.00 | 100.00 | 100.00 |
| Peel | 50% RH 1 day | 323.34 | 112.92 | 144.52 | 239.30 | 142.04 | 64.65 |
| Strength | 50% RH 1 day and | 243.23 | 69.75 | 117.01 | 195.33 | 150.94 | 34.98 |
| (g/in) | 95% RH 1 day | | | | | | |
| PhotoDSC | Apr. 17, 2001 | 44.9 | 58.4 | 59.2 | 56.2 | 27.5 | 63.0 |
| | Apr. 18, 2001 | 35.1 | Not Run | Not Run | 57.9 | 30.5 | Not Run |
| | Apr. 26, 2001 | 33.5 | Not Run | Not Run | 62.1 | 21.9 | 64.4 |

TABLE 12

| Material | | 24 | 25 | 26 | 27 | 28 | 29 | 30 |
|---|---|---|---|---|---|---|---|---|
| 408-200 | | 72.00 | 72.00 | 73.86 | 71.99 | 73.49 | 72.00 | 74.62 |
| A-189 | | 0.08 | 0.26 | — | 0.11 | — | — | — |
| Y-11597 | | 0.77 | 1.15 | 0.04 | 0.24 | — | — | — |
| NTX-4456 | | 0.65 | — | — | 0.43 | — | 0.56 | — |
| A-172 | | — | — | — | 1.50 | — | 1.50 | — |
| Z-6075 | | — | 1.50 | 0.56 | 0.24 | 1.50 | 0.94 | — |
| SIB1833 | | 1.50 | 0.09 | 0.37 | 0.49 | — | — | 0.38 |
| Acetic Acid | | — | — | — | — | 0.01 | — | — |
| A-187 | | — | — | 0.17 | — | — | — | — |
| Total | | 75.00 | 75.00 | 75.00 | 75.00 | 75.00 | 75.00 | 75.00 |
| Color - UV/Vis (Absorbance) | | 0.0813 | 0.0626 | 0.0753 | 0.0700 | Not Run | 0.0662 | 0.0829 |
| Clarity - UV/Vis (Absorbance) | | 0.021 | −0.0003 | −0.0090 | −0.0075 | Not Run | −0.0137 | 0.0017 |
| 25° C. Viscosity (cps) | | 6110 | 5110 | 5090 | 5250 | 5670 | 5750 | 6090 |
| Peel Strength | 50% RH 1 day | 462.39 | 436.75 | 239.87 | 356.44 | 216.39 | 276.41 | 312.75 |
| (g/in) | 50% RH 1 day | 278.20 | 437.52 | 137.35 | 258.17 | 132.30 | 219.94 | 234.62 |
| | and | | | | | | | |
| | 95% RH 1 day | | | | | | | |

| | | | | | | | |
|---|---|---|---|---|---|---|---|
| Retained Peel Strength (%) | 60.17 | 100.18 | 57.26 | 72.43 | 61.14 | 79.57 | 75.02 |

TABLE 13

| Material | | 31 | 32 | 33 | 34 | 35 | 36 | 37 |
|---|---|---|---|---|---|---|---|---|
| 408-200 | | 74.24 | 73.50 | 73.50 | 73.50 | 73.86 | 74.62 | — |
| 98-1 | | — | — | — | — | — | — | 75.00 |
| A-189 | | — | — | — | — | 0.37 | — | — |
| Z-6032 | | — | 1.50 | — | — | — | — | — |
| A-187 | | — | — | — | — | 0.17 | — | — |
| A-174 | | — | — | — | — | 0.56 | — | — |
| Y-11597 | | — | — | — | — | 0.04 | — | — |
| Z-6075 | | 0.38 | — | 1.50 | — | — | — | — |
| SIB1833 | | 0.38 | — | — | — | — | 0.38 | — |
| NTX-4456 | | — | — | — | 1.50 | — | — | — |
| Total | | 75.00 | 75.00 | 75.00 | 75.00 | 75.00 | 75.00 | 75.00 |
| Color - 450 nm (Absorbance) | | Not Run | 2.6780 | 0.0609 | 0.0625 | Not Run | Not Run | 0.3989 |
| Clarity - 500 nm (Absorbance) | | Not Run | 2.4740 | −0.0115 | −0.0138 | Not Run | Not Run | 0.6162 |
| 25° C. Viscosity (cps) | | 6340 | 6170 | 5610 | 5810 | 5500 | 5600 | Not Run |
| Peel Strength | 50% RH 1 day | 280.35 | 363.34 | 220.37 | 404.82 | 141.44 | 484.35 | 117.62 |
| (g/in) | 50% RH 1 day | 265.99 | 296.16 | 138.90 | 264.32 | 176.49 | 381.35 | 91.40 |
| | and | | | | | | | |
| | 95% RH 1 day | | | | | | | |

| | | | | | | | |
|---|---|---|---|---|---|---|---|
| Retained Peel Strength (%) | 94.88 | 81.51 | 63.03 | 65.29 | 124.78 | 78.73 | 77.71 |

TABLE 14

| | | | Relative | Modulus (psi) | | |
|---|---|---|---|---|---|---|
| | | | Cure | | | Cure |
| Formula | Silane | Amount | Speed | 200 mJ | 1000 mJ | Ratio |
| 38 | A-189 | 0.50 | 43.3% | 179.4 | 205.0 | 87.5% |
| 39 | A-189 | 1.00 | 52.6% | 139.9 | 169.4 | 82.6% |
| 40 | A-189 | 2.00 | 38.1% | 0.0 | 0.0 | 0.0% |
| 41 | CD 9051 | 0.50 | 42.5% | 154.3 | 215.4 | 71.6% |
| 42 | CD 9051 | 1.00 | 32.7% | 171.7 | 205.6 | 83.5% |
| 43 | CD 9051 | 2.00 | 16.6% | 139.9 | 215.1 | 65.1% |
| 44 | SIB1833 | 0.50 | 62.9% | 187.7 | 235.1 | 79.9% |
| 45 | SIB1833 | 1.00 | 69.2% | 218.0 | 251.9 | 86.5% |
| 46 | SIB1833 | 2.00 | 61.6% | 202.7 | 240.2 | 84.4% |
| 47 | NTX4456 | 0.50 | 66.7% | 205.2 | 240.5 | 85.3% |
| 48 | NTX4456 | 1.00 | 73.5% | 201.8 | 232.8 | 86.7% |
| 49 | NTX4456 | 2.00 | 67.8% | 202.5 | 245.6 | 82.4% |
| 50 | Y11597 | 0.50 | 73.2% | 212.7 | 250.3 | 85.0% |
| 51 | Y11597 | 1.00 | 77.0% | 216.4 | 236.2 | 91.6% |
| 52 | Y11597 | 2.00 | 61.8% | 228.0 | 247.4 | 92.2% |
| 53 | None | 0.00 | 51.7% | 243.2 | 254.4 | 95.6% |

TABLE 15

| | | | | | | | | | Peel Strength (gf/in) | | |
|---|---|---|---|---|---|---|---|---|---|---|---|
| | | | | | | | | | | 1 day @ | |
| | | | | | | | | | | 50% RH | Retained |
| | | | | | | | Base | | | and | Peel |
| | A-189 | A-172 | Y-11597 | Z-6075 | NTX-4456 | SIB1833 | Mix | Total | 1 day @ | 1 day @ | Strength |
| Sample | grams | grams | grams | grams | grams | grams | grams | grams | 50% RH | 95% RH | (gf/in) |
| 54 | — | 1.00 | — | — | — | 1.00 | 48.00 | 50.00 | 313.14 | 321.99 | 102.83% |
| 55 | — | 1.00 | 1.00 | — | — | — | 48.00 | 50.00 | 286.11 | 356.44 | 124.58% |
| 56 | 1.00 | 1.00 | — | — | — | — | 48.00 | 50.00 | 211.20 | 313.13 | 148.26% |
| 57 | 1.00 | — | — | 1.00 | — | — | 48.00 | 50.00 | 344.71 | 356.48 | 103.42% |
| 58 | — | — | — | 1.00 | — | 1.00 | 48.00 | 50.00 | 358.99 | 334.34 | 93.13% |
| 59 | — | 0.67 | — | 0.67 | — | 0.67 | 48.00 | 50.01 | 414.11 | 343.35 | 82.91% |
| 60 | 0.67 | 0.67 | — | 0.67 | — | — | 48.00 | 50.01 | 220.17 | 216.76 | 98.45% |
| 61 | 0.67 | 0.67 | 0.67 | — | — | — | 48.00 | 50.01 | 255.19 | 468.56 | 183.62% |
| 62 | — | 0.67 | 0.67 | — | — | 0.67 | 48.00 | 50.01 | 376.19 | 454.39 | 120.79% |
| 63 | — | 0.67 | 0.67 | — | 0.67 | — | 48.00 | 50.01 | 432.82 | 394.72 | 91.20% |
| 64 | — | — | 0.67 | 0.67 | — | 0.67 | 48.00 | 50.01 | 495.99 | 434.87 | 87.68% |

What is claimed is:

1. A coated optical fiber comprising: an optical fiber; and a radiation-cured coating on the optical fiber, wherein the coating is formed from a mixture comprising:
one or more radiation curable pre-polymers,
about 0.05 to about 30 weight percent adhesion promoter comprising one or more bis-silyl amines of formula I 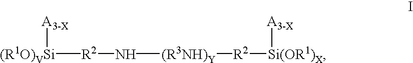
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates.

2. A coated optical fiber comprising: an optical fiber; and a radiation-cured coating on the optical fiber, wherein the coating is formed from a mixture of:
(I) one or more oligomers,
(II) optionally, a reactive diluent;
(III) about 0.05 to about 30 weight percent one or more bis-silyl amines of formula I: 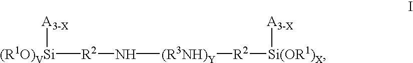
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates;
(IV) 0 to about 10 percent by weight of one or more photoinitiators; and
(V) 0 to about 10 percent by weight of one or more additives such as light sensitive and light absorbing components, catalysts, lubricants, inhibitors, wetting agents, antioxidants, stabilizers, pigments and dyes.

3. A coated optical fiber comprising: an optical fiber; and a radiation-cured coating on the optical fiber, wherein the coating is formed from a mixture of:
(I) about 5 to 95 weight percent, typically 10 percent to about 90 percent, by weight of one or more oligomers,
(II) about 5 to about 95 weight percent of a reactive diluent;
(III) about 0.05 to about 30 weight percent one or more a bis-silyl amine of formula I 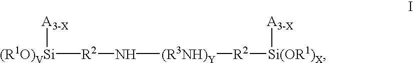
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the provisos that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates;
(IV) 0 to about 10 percent by weight of one or more photoinitiators; and
(V) 0 to about 10 percent by weight of one or more additives such as light sensitive and light absorbing components, catalysts, lubricants, inhibitors, wetting agents, antioxidants, stabilizers, pigments and dyes.

4. The optical fiber of claim 1, wherein the one or more bis-silyl amine of formula I 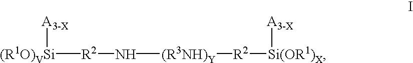
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates.

5. The optical fiber of claim 1, wherein the mixture comprises about 0.2 to about 2 weight percent, of the one or more trimethoxysilylpropyl amine adhesion promoters.

6. The optical fiber of claim 1, wherein the one or more trimethoxysilylpropyl amine adhesion promoters comprises bis(trimethoxysilylpropyl) amine.

7. The optical fiber of claim 1, wherein the base oligomer comprises a urethane acrylate oligomer.

8. The optical fiber of claim. 1, wherein the at least one base oligomer further comprises at least one radiation-curable diphenylmethane polyol oligomer, wherein each terminus of the diphenylmethane polyol oligomer is capped by a reactive acrylate moiety.

9. The optical fiber of claim 8, wherein the diphenylmethane polyol oligomer comprises no more than two acrylate moieties.

10. The optical fiber of claim 8, wherein the coating comprises from about 10 weight percent to about 90 weight percent of the urethane acrylate oligomer, from about 5 weight percent to about 80 weight percent of the polyol oligomer, from about 10 weight percent to about 80 weight percent of a reactive diluent and from about 0 weight percent to about 10 weight percent of a photoinitiator.

11. The optical fiber of claim 8, wherein the coating comprises from about 40 weight percent to about 80 weight percent of the urethane acrylate oligomer, from about 20 weight percent to about 50 weight percent of the polyol oligomer, from about 20 weight percent to about 65 weight percent of the reactive diluent and from about 1 weight percent to about 5 weight percent of the photoinitiator.

12. The optical fiber of claim 1, wherein the coating exhibits a UV absorbance at 500 nm relative to distilled water of less than about 0.04.

13. The optical fiber of claim 1, wherein the coating exhibits a UV absorbance at 500 nm relative to distilled water of less than about 0.02.

14. The optical fiber of claim 1, wherein the coating comprised of the one or more adhesion promoters is a primary coating on the fiber.

15. The optical fiber of claim 1, wherein the coating comprised of the one or more adhesion promoters is a primary coating on the fiber.

16. The optical fiber of claim 1, wherein the coating comprised of the one or more adhesion promoters is a secondary coating on the fiber.

17. The optical fiber of claim 2, wherein the coating comprised of the one or more adhesion promoters is a secondary coating on the fiber.

18. The optical fiber of claim 1, wherein the base oligomer, polyol oligomer and reactive diluent are selected such that a mixture thereof is liquid at 5 to 25° C.

19. An optical ribbon comprising a plurality of optical fibers of claim 1 and a matrix material, the plurality of fibers held together in a parallel arrangement by the matrix material.

20. A composition for coating optical fibers comprising
one or more radiation curable pre-polymers,
about 0.05 to about 30 weight percent adhesion promoter comprising one or more bis-silyl amines of formula I 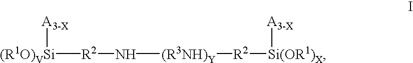
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates.

21. A composition comprising:
(I) one or more oligomers,
(II) a reactive diluent;
(III) about 0.05 to about 30 weight percent one or more a bis-silyl amine of formula I 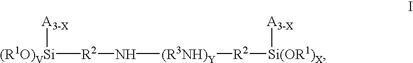
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when-the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates, and
(IV) 0 to about 10 percent by weight of one or more photoinitiators; and
(V) 0 to about 10 percent by weight of one or more additives such as light sensitive and light absorbing components, catalysts, lubricants, inhibitors, wetting agents, antioxidants, stabilizers, pigments and dyes.

22. A composition comprising:
(I) about 5 to 95 weight percent, typically 10 percent to about 90 percent, by weight of one or more oligomers,
(II) about 5 to about 95 weight percent of a reactive diluent;
(III) about 0.05 to about 30 weight percent one or more bis-silyl amines of formula I: 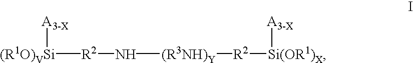
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates;
(IV) 0 to about 10 percent by weight of one or more photoinitiators; and
(V) 0 to about 10 percent by weight of one or more additives such as light sensitive and light absorbing components, catalysts, lubricants, inhibitors, wetting agents, antioxidants, stabilizers, pigments and dyes.

23. The composition claim 22, wherein the one or more bis-silyl amines has a formula I: 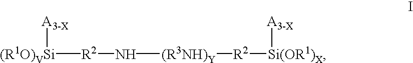
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates.

24. A process for preparing a coated optical fiber comprising:
applying to an optical fiber a coating formed from a reaction mixture comprising: one or more radiation curable pre-polymers,
about 0.05 to about 30 weight percent adhesion promoter comprising one or more bis-silyl amines of formula I 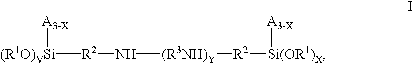
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates; and
0 to about 10 percent by weight of one or more photoinitiators.

25. A process for preparing a coated optical fiber comprising:
applying to an optical fiber a coating formed from a reaction mixture comprising:
(I) one or more oligomers,
(II) optionally, a reactive diluent;
(III) about 0.05 to about 30 weight percent one or more bis-silyl amines of formula I 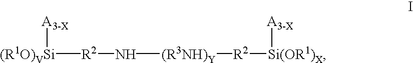
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates;
(IV) 0 to about 10 percent by weight of one or more photoinitiators; and
(V) 0 to about 10 percent by weight of one or more additives such as light sensitive and light absorbing components, catalysts, lubricants, inhibitors, wetting agents, antioxidants, stabilizers, pigments and dyes.

26. A process for preparing a coated optical fiber comprising:
applying to an optical fiber a coating formed from a reaction mixture:
(I) about 5 to 95 weight percent, typically 10 percent to about 90 percent, by weight of one or more oligomers,
(II) about 5 to about 95 weight percent of a reactive diluent;
(III) about 0.05 to about 30 weight percent one or more bis-silyl amines of formula I 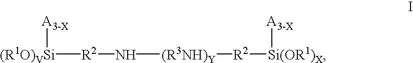
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates;
(IV) 0 to about 10 percent by weight of one or more photoinitiators; and
(V) 0 to about 10 percent by weight of one or more additives such as light sensitive and light absorbing components, catalysts, lubricants, inhibitors, wetting agents, antioxidants, stabilizers, pigments and dyes.

27. The process claim 26, wherein the one or more bis-silyl amines have a formula I: 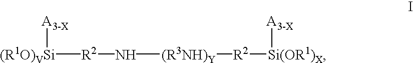
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates; and
radiation-curing said coating in situ.

28. The fiber of claim 1, wherein the cure speed of the composition is at least as fast as the same composition without the adhesion promoter.

29. The fiber of claim 1, wherein the adhesion of the composition to the fiber after aging is sufficient to prevent delamination of the coating to the glass while enabling stripability of the final assembly.

30. The fiber of claim 1, wherein the ratio of the adhesion of the composition to glass at 50%RH for 16 to 24 hours to the adhesion at 95% RH for 16 to 24 hours remains between 1:0.75 to 1:1.5.

31. A coated optical fiber comprising: an optical fiber; and a radiation-cured coating on the optical fiber, wherein the coating is formed from a mixture comprising:
one or more radiation curable pre-polymers,
about 0.05 to about 30 weight percent adhesion promoter, wherein the adhesion promoter does not undergo a free radical reaction with the pre-polymer but is reactive with glass.

32. The coated fiber of claim 31, wherein said adhesion promoters comprising one or more bis-silyl amines of formula I 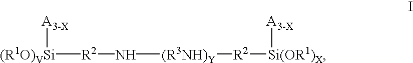
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates; and
0 to about 10 percent by weight of one or more photoinitiators.

33. The coated optical fiber of claim 31, wherein the coating is formed from a mixture comprising:
one or more radiation curable pre-polymers,
about 0.05 to about 30 weight percent adhesion promoter comprising one or more bis-silyl amines of formula I 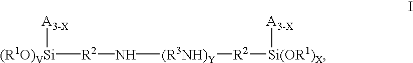
wherein each R¹ is independently C1-C4 alkyl, preferably C1 or C2 alkyl;
wherein each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
each R² group is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
each R³ is independently selected from the group consisting of C1-C15 alkyl, preferably C1-C4 alkyl, typically C2 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl; and C12-C15 substituted or unsubstituted bis-cyclic hydrocarbon, e.g., bis-phenol A radical;
X is 1 to 3;
V is 1 to 3; and
Y is 0 to 1,
with the proviso that when the adhesion promoter contains bis(trimethoxysilyl)propylamine the coating composition (i) is free of oligomer having a saturated aliphatic backbone between at least two of the terminal ends with at least one epoxide group and/or (ii) comprises at least one adhesion promoter selected from the group consisting of a bis-silyl amines other than bis(trimethoxysilyl)propylamine, diacrylated silane tertiary amine, acetoxy functional silanes, and trifunctional isocyanurates; and
0 to about 10 percent by weight of one or more photoinitiators.

34. The coated optic fiber of claim 33, wherein the curable composition comprises about 0.05 to about 10 percent by weight of the one or more photoinitiators.

35. A coated optical fiber comprising: an optical fiber; and a radiation-cured coating on the optical fiber, wherein the coating is formed from a mixture comprising:
one or more radiation curable pre-polymers,
about 0.05 to about 30 weight percent adhesion promoter comprising one or more diacrylated silane based on tertiary amine having the following Formula IV. 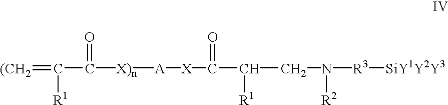
wherein R¹ is H or CH₃; n is 1 to 2; A is a bivalent linking group; X is O, S, NH; R² is H or a C1-C20 organic group; R3 is a divalent linking group; and each of Y¹ Y²Y³ which may be the same or different, represents alkoxyl, carboxy alkoxy ether, alkyl or aryl.

36. A coated optical fiber comprising: an optical fiber; and a radiation-cured coating on the optical fiber, wherein the coating is formed from a mixture comprising:
one or more radiation curable pre-polymers,
about 0.05 to about 30 weight percent adhesion promoter comprising Sartomer (NTX4456) diacrylated silane tertiary amine.

37. The fiber of claim 35, wherein the cure speed of the composition is at least as fast as the same composition without the adhesion promoter.

38. The fiber of claim 35, wherein the adhesion of the composition to the fiber after aging is sufficient to prevent delamination of the coating to the glass while enabling stripability of the final assembly.

39. The fiber of claim 35, wherein the ratio of the adhesion of the composition to glass at 50%RH for 16 to 24 hours to the adhesion at 95% RH for 16 to 24 hours remains between 1:0.75 to 1:1.5.

40. A coated optical fiber comprising: an optical fiber; and a radiation-cured coating on the optical fiber, wherein the coating is formed from a mixture comprising:
one or more radiation curable pre-polymers,
about 0.05 to about 30 weight percent adhesion promoter comprising one or more acetoxy Functional Silanes having the Formula VII. 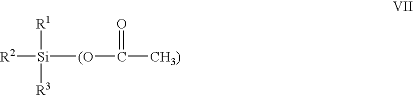
wherein R¹ and R² are independently selected from the group consisting of 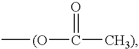
H, C1-C4 alkyl, phenyl, cyclohexyl, CH₂═CH₂, acrylate and C1-C4 alkoxy; and
R³ is independently selected from the group consisting of
C1-C4 alkyl, phenyl, cyclohexyl, CH₂═CH₂, acrylate and C1-C4 alkoxy.

41. The fiber of claim 40, wherein the compounds of Formula VII are do not have free radical reaction with the radiation curable pre-polymer, wherein R¹, R² and R³ do not contain a carbon to carbon double bond.

42. The fiber of claim 40, wherein the adhesion promoter comprises one or more members of the group consisting of: vinyltriacetoxy-silane, dimethyldiacetoxy-silane, vinylmethyl-diacetoxysilane, methyltriacetoxy-silane, di-t-butoxydiacetoxysilane, dimethyldiacetoxysilane, diphenyldiacetoxysilane, ethyltriacetoxysilane, methyldiacetoxysilane, methyltriacetoxysilane, phenyldimethylacetoxysilane, phenyltriacetoxysilane, triethylacetoxysilane, vinylmethyldiacetoxysilane, and mixtures thereof.

43. The fiber of claim 40, wherein the cure speed of the composition is at least as fast as the same composition without the adhesion promoter.

44. The fiber of claim 40, wherein the adhesion of the composition to the fiber after aging is sufficient to prevent delamination of the coating to the glass while enabling stripability of the final assembly.

45. The fiber of claim 40, wherein the ratio of the adhesion of the composition to glass at 50%RH for 16 to 24 hours to the adhesion at 95% RH for 16 to 24 hours remains between 1:0.75 to 1:1.5.

46. A coated optical fiber comprising: an optical fiber; and a radiation-cured coating on the optical fiber, wherein the coating is formed from a mixture comprising:
one or more radiation curable pre-polymers,
about 0.05 to about 30 weight percent adhesion promoter comprising one or more trifunctional isocyanurates having a 6 membered heterocyclic ring of 3 carbon atoms alternating with 3 nitrogen atoms, wherein each nitrogen atom is substituted with an R⁵ group and each R⁵ is independently selected from the group consisting of C1-C6 alkyl (typically C1, C2, C3 or C4 alkyl), vinyl, acetoxy, meth(acrylate), phenyl, cycloalkanes, and bis-phenyol A radical, and 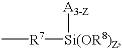
wherein R⁷ is C1-C6 alkyl, for example C3, C4, C5 or C6, R⁸ is C1-C4 alkyl, for example, C3 or C4, and Z is 1, 2 or 3, wherein at least one R⁵ is —R⁷—Si(OR8)_{z}, and each A is independently selected from the group consisting of C1-C15 alkyl, preferably C1-C4 alkyl, C1-C15 substituted or unsubstituted cyclic alkyl, e.g., cyclohexyl, C1-C15 heterocyclic alkyl; C6-C15 substituted or unsubstituted aromatic hydrocarbon, e.g., phenyl;
with the proviso that when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines, diacrylated silane tertiary amine, acetoxy functional silanes, trifunctional isocyanurates other than tris[(trimethoxysilyl)propyl]-isocyanurate.

47. The fiber of claim 46, wherein when the adhesion promoter contains tris[(trimethoxysilyl)propyl]-isocyanurate the coating composition (i) is free of oligomer having a saturated aliphatic backbone between at least two of the terminal ends with at least one epoxide group and/or (ii) comprises at least one adhesion promoter selected from the group consisting of bis-silyl amines other than bis(trimethoxysilyl)propylamine, diacrylated silane tertiary amine, acetoxy functional silanes, trifunctional isocyanurates other than tris[(trimethoxysilyl)propyl]-isocyanurate.

48. The fiber of claim 46, wherein the cure speed of the composition is at least as fast as the same composition without the adhesion promoter.

49. The fiber of claim 46, wherein the adhesion of the composition to the fiber after aging is sufficient to prevent delamination of the coating to the glass while enabling stripability of the final assembly.

50. The fiber of claim 46, wherein the ratio of the adhesion of the composition to glass at 50%RH for 16 to 24 hours to the adhesion at 95% RH for 16 to 24 hours remains between 1:0.75 to 1:1.5.

51. A coated optical fiber comprising: an optical fiber; and a radiation-cured coating on the optical fiber, wherein the coating is formed from a mixture comprising:
one or more radiation curable pre-polymers, and
about 0.05 to about 30 weight percent adhesion promoter comprising one or more Adhesion Promoters which are silanes which do not couple with a backbone of the coating polymer.

52. The fiber of claim 51 wherein the adhesion promoter comprises the bis-silyl amines of Formula I, such as, bis(trimethoxysilyl)propylamine, dimethyldiacetoxy silane, epoxy functional silanes, and tris[(trimethoxysilyl)propyl]-isocyanurate and mixtures thereof.

53. The fiber of claim 51, wherein the cure speed of the composition is at least as fast as the same composition without the adhesion promoter.

54. The fiber of claim 51, wherein the adhesion of the composition to the fiber after aging is sufficient to prevent delamination of the coating to the glass while enabling stripability of the final assembly.

55. The fiber of claim 51, wherein the ratio of the adhesion of the composition to glass at 50%RH for 16 to 24 hours to the adhesion at 95% RH for 16 to 24 hours remains between 1:0.75 to 1:1.5.

56. A method for improving the ratio of the adhesion of a radiation cured coating composition to optic fiber comprising providing a radiation curable composition comprising about 0.05 to about 30 weight percent one or more adhesion promoters which are silanes which do not couple with a backbone of the coating polymer.

57. A process for preparing a coated optical fiber comprising:
applying to an optical fiber a coating formed from a reaction mixture comprising: one or more radiation curable pre-polymers,
about 0.05 to about 30 weight percent adhesion promoter comprising one or more adhesion promoters of the composition of claim 35.

58. A process for preparing a coated optical fiber comprising:
applying to an optical fiber a coating formed from a reaction mixture comprising: one or more radiation curable pre-polymers,
about 0.05 to about 30 weight percent adhesion promoter comprising one or more adhesion promoters of the composition of claim 37.

59. A process for preparing a coated optical fiber comprising:
applying to an optical fiber a coating formed from a reaction mixture comprising: one or more radiation curable pre-polymers,
about 0.05 to about 30 weight percent adhesion promoter comprising one or more adhesion promoters of the composition of claim 39.

60. A process for preparing a coated optical fiber comprising:
applying to an optical fiber a coating formed from a reaction mixture comprising: one or more radiation curable pre-polymers,
about 0.05 to about 30 weight percent adhesion promoter comprising one or more adhesion promoters of the composition of claim 41.

61. A method comprising applying a curable composition comprising applying to a glass optic fiber at least one adhesion promoter of claim 1, wherein coated glass fiber dynamic tensile strength is maintained after aging according to TIA/EIA-455-28C (Revision of EIA/TIA-455-28B, April 1999, Telecommunications Industry Association).

62. A method comprising applying a curable composition comprising applying to a glass optic fiber at least one adhesion promoter of claim 34, wherein coated glass fiber dynamic tensile strength is maintained after aging according to TIA/EIA-455-28C (Revision of EIA/TIA-455-28B, April 1999, Telecommunications Industry Association).

63. A method comprising applying a curable composition comprising applying to a glass optic fiber at least one adhesion promoter of claim 39, wherein coated glass fiber dynamic tensile strength is maintained after aging according to TIA/EIA-455-28C (Revision of EIA/TIA-455-28B, April 1999, Telecommunications Industry Association).

64. A method comprising applying a curable composition comprising applying to a glass optic fiber at least one adhesion promoter of claim 40, wherein coated glass fiber dynamic tensile strength is maintained after aging according to TIA/EIA-455-28C (Revision of EIA/TIA-455-28B, April 1999, Telecommunications Industry Association).

65. A method comprising applying a curable composition comprising applying to a glass optic fiber at least one adhesion promoter of claim 45, wherein coated glass fiber dynamic tensile strength is maintained after aging according to TIA/EIA-455-28C (Revision of EIA/TIA-455-28B, April 1999, Telecommunications Industry Association).

66. A method comprising applying a curable composition comprising applying to a glass optic fiber at least one adhesion promoter of claim 1, wherein the adhesion promoters which are compatible with the coating formulation to not adversely affect clarity.

67. A method comprising applying a curable composition comprising applying to a glass optic fiber at least one adhesion promoter of claim 34, wherein the adhesion promoters which are compatible with the coating formulation to not adversely affect clarity.

68. A method comprising applying a curable composition comprising applying to a glass optic fiber at least one adhesion promoter of claims 39, wherein the adhesion promoters which are compatible with the coating formulation to not adversely affect clarity.

69. A method comprising applying a curable composition comprising applying to a glass optic fiber at least one adhesion promoter of claim 40, wherein the adhesion promoters which are compatible with the coating formulation to not adversely affect clarity.

70. A method comprising applying a curable composition comprising applying to a glass optic fiber at least one adhesion promoter of claim 45, wherein the adhesion promoters which are compatible with the coating formulation to not adversely affect clarity.

71. A method comprising applying a curable composition comprising applying to a glass optic fiber at least one adhesion promoter of claim 1, wherein the at least one adhesion promoter maintains adhesion and corrosion resistance in accelerated aging (95% relative humidity soaking in water, and thermal aging).

72. A method comprising applying a curable composition comprising applying to a glass optic fiber at least one adhesion promoter of claim 34, wherein the at least one adhesion promoter maintains adhesion and corrosion resistance in accelerated aging (95% relative humidity soaking in water, and thermal aging).

73. A method comprising applying a curable composition comprising applying to a glass optic fiber at least one adhesion promoter of claim 39, wherein the at least one adhesion promoter maintains adhesion and corrosion resistance in accelerated aging (95% relative humidity soaking in water, and thermal aging).

74. A method comprising applying a curable composition comprising applying to a glass optic fiber at least one adhesion promoter of claim 40, wherein the at least one adhesion promoter maintains adhesion and corrosion resistance in accelerated aging (95% relative humidity soaking in water, and thermal aging).

75. A method comprising applying a curable composition comprising applying to a glass optic fiber at least one adhesion promoter of claim 45, wherein the at least one adhesion promoter maintains adhesion and corrosion resistance in accelerated aging (95% relative humidity soaking in water, and thermal aging).

76. A method comprising applying a curable composition comprising applying to a glass optic fiber at least one adhesion promoter of claim 1, wherein the adhesion of the coating on the glass optic fiber is improved without significantly decreasing the cure speed compared to a composition which is the same but for lacking the at least one adhesion promoter.

77. A method comprising applying a curable composition comprising applying to a glass optic fiber at least one adhesion promoter of claim 34, wherein the adhesion of the coating on the glass optic fiber is improved without significantly decreasing the cure speed compared to a composition which is the same but for lacking the at least one adhesion promoter.

78. A method comprising applying a curable composition comprising applying to a glass optic fiber at least one adhesion promoter of claim 39, wherein the adhesion of the coating on the glass optic fiber is improved without significantly decreasing the cure speed compared to a composition which is the same but for lacking the at least one adhesion promoter.

79. A method comprising applying a curable composition comprising applying to a glass optic fiber at least one adhesion promoter of claim 40, wherein the adhesion of the coating on the glass optic fiber is improved without significantly decreasing the cure speed compared to a composition which is the same but for lacking the at least one adhesion promoter.

80. A method comprising applying a curable composition comprising applying to a glass optic fiber at least one adhesion promoter of claim 45, wherein the adhesion of the coating on the glass optic fiber is improved without significantly decreasing the cure speed compared to a composition which is the same but for lacking the at least one adhesion promoter.
